(19) United States
(12) Patent Application Publication
(10) Pub. No.: US 2024/0218227 A1
(43) Pub. Date: Jul. 4, 2024

(54) STABILIZED FLUOROETHYLENE COMPOSITIONS AND METHODS FOR THEIR STORAGE AND USAGE

(71) Applicant: THE CHEMOURS COMPANY FC, LLC, WILMINGTON, DE (US)

(72) Inventors: SHENG PENG, HOCKESSIN, DE (US); LUKE DAVID SIMONI, WILMINGTON, DE (US); JOSHUA HUGHES, WILMINGTON, DE (US); BARBARA HAVILAND MINOR, THE VILLAGES, FL (US)

(73) Assignee: THE CHEMOURS COMPANY FC, LLC, WILMINGTON, DE (US)

(21) Appl. No.: 18/569,449

(22) PCT Filed: Jul. 11, 2022
(86) PCT No.: PCT/US22/36661

§ 371 Date: Dec. 12, 2023

Related U.S. Application Data
(60) Provisional application No. 63/220,717, filed on Jul. 12, 2021.
(60) Provisional application No. 63/334,442, filed on Apr. 25, 2022.

(51) Int. Cl. C09K 5/04

(52) U.S. Cl. CPC C09K 5/045; C09K 2205/126

(57) ABSTRACT

The present invention relates to stabilized compositions comprising at least one fluoroethylene and an effective amount of at least one inhibitor. The composition is substantially free of oligomeric, homopolymers or other polymeric products derived from the fluoroethylene. The stabilized compositions may be useful in cooling apparatus, such as refrigeration, air-conditioning, chillers, and heat pumps, as well as in applications as foam blowing agents, solvents, aerosol propellants, fire extinguishants, and sterilants.

### CROSS REFERENCE TO RELATED APPLICATIONS

This application is a national stage filing under 35 U.S.C. 371 of International Application PCT/US2022/036661 filed Jul. 11, 2022, and claims the benefit of priority of U.S. Provisional Application 63/220,717 filed Jul. 12, 2021, and U.S. Provisional Application 63/334,442 filed Apr. 25, 2022, the disclosures of which are incorporated herein by reference it its entirety.

### BACKGROUND OF THE INVENTION

### 1. Field of the Invention

The present invention relates broadly to stabilized compositions comprising at least one fluoroethylene and at least one inhibitor and methods for their storage and use.

### 2. Description of Related Art

New environmental regulations on refrigerants have forced the refrigeration and air-conditioning industry to look for new refrigerants with low global warming potential (GWP).

Replacement refrigerants are being sought that have low GWP, no toxicity, non-flammability, reasonable cost, and excellent refrigeration performance.

Fluoroethylenes have been proposed as refrigerants, alone or in mixtures, due, in some cases, to their low boiling points. However, it has been observed that certain fluoroethylenes can exhibit degradation and/or produce unwanted by-products under certain conditions, such as, for example, extreme temperatures or contact with other compounds in a contaminated system (e.g., excessive oxygen, oxidizing chemicals, or radical-generating compounds, among various contaminants) that might occur unexpectedly in a particular use and/or application. Such degradation may occur when fluoroethylenes are utilized as refrigerants or heat transfer fluids. This degradation may occur by any number of different mechanisms.

Under certain conditions and/or in the presence of undesired contaminants that could function as an initiator, fluoroethylenes may oligomerize or homopolymerize. Accordingly, there is a need in this art for stabilized fluoroethylene-containing compositions having a reduced, if not eliminated, potential to oligomerize or homopolymerize as well as co-polymerize with compounds such as hydrofluoroolefins (such as HFO-1234yf and HFO-1132A).

### SUMMARY OF THE INVENTION

The present invention can improve the ability of a fluoroethylene-containing composition to withstand abnormal conditions, and also solves potential problems associated with initiators (e.g., contaminants) causing a fluoroethylene to oligomerize or homopolymerize, by adding at least one inhibitor to a fluoroethylene-containing composition. The present invention can also solve problems associated with polymerization initiation by providing at least one inhibitor that is present in a liquid and/or a vapor fluoroethylene-containing composition as well as a lubricant. By “inhibitor” it is meant to refer to at least one compound in accordance with the present invention that reduces, if not eliminates, conversion of fluoroethylenes into oligomers or polymers. While oligomerization or homopolymerization reactions may be accelerated by relatively high temperatures, such reactions may also occur under ambient conditions depending upon the concentration and type of initiator (e.g., contaminant). The inhibitor can function as a radical inhibitor and without affecting the refrigeration performance or compatibility of the composition with refrigerant oil and parts. The stabilized compositions may be useful in cooling systems and as replacements for existing refrigerants with higher global warming potential.

To avoid possible instability of the fluoroethylenes, it has been found that adding certain inhibitor compounds, namely hydrocarbons comprising at least one of cyclic monoterpene; lipophilic organic compounds including tocopherols such as α-tocopherol; or phenols, aromatic organic compounds having at least one chemical moiety —C₆H₄(OH), including benzene-1,4-diol, to fluoroethylene-containing compositions increases the stability thereof during packaging, storage, and usage, such as in refrigeration or air-conditioning system applications. Specific examples of inhibitor compounds comprise at least one member selected from the group consisting of limomene, α-terpinene, α-tocopherol, butylated hydroxytoluene (BHT), 4-methoxyphenol, and benzene-1,4-diol.

In one particular embodiment, the invention relates to fluoroethylene-containing compositions comprising an inhibitor that can interact or react with O₂ and fluoroolefin polyperoxides and in turn inhibit or preclude reaction of such compounds with a fluoroethylene. Examples of such an inhibitor comprise at least one of limonene and α-terpinene. Limonene and α-terpinene have the following structures:

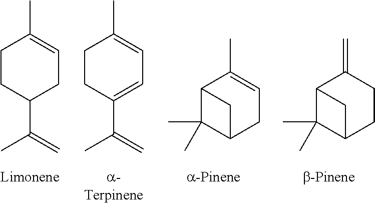

In one embodiment of the invention, the inhibitor comprises α-terpinene. Without wishing to be bound by any theory or explanation, it is believed that due to the presence of the conjugated double bond in its structure, α-terpinene can form an aromatic ring upon oxidation.

In one embodiment of the invention, limonene or α-terpinene optionally with an antioxidant has a unique fragrance even at a few ppm level. This pleasant odor can be utilized for refrigerant leakage detection with refrigerant and blends based on at least one fluoroethylene. This is especially beneficial for early refrigerant leakage detection in household air conditioner or mobile air conditioner as paraprofessional electronic leak detectors often are not available in either location.

In another embodiment of the invention, at least one of the following inhibitors can used alone or in combinations with the foregoing inhibitors: Meta-xylene, ortho-xylene, para-xylene, alpha-methylstyrene, alpha meta-methylstyrene, alpha ortho-methylstyrene, and alpha para-methylstyrene.

One embodiment of the invention relates to a stabilized composition comprising:
a. at least one fluoroethylene; and
b. an effective amount of at least one inhibitor, wherein the composition is substantially free of oligomeric, homopolymers or other polymeric products derived from the fluoroethylene.

One embodiment relates to the at least one fluoroethylene comprising at least one difluoroethylene.

One particular embodiment relates to the at least one difluoroethylene comprising 1,1-difluoroethylene (HFO-1132a).

Another particular embodiment relates to the at least one difluoroethylene comprising 1,1-difluoroethylene, (E)-1,2-difluoroethylene and (Z)-1,2-difluoroethylene. Another particular embodiment relates to any of the foregoing compositions combined with at least one of HFO-1234yf and HFC-32. The amount of HFO-1234yf and/or HFC-32 can range from about 50 to about 95 wt. %, about 60 to about 90 wt. % and in some cases about 65 to about 80 wt. %. In one aspect of this particular embodiment, the composition comprises R1132(E)/R1234yf at 23/77 wt % (which is useful in a wide range of applications including in a heat pump for an electric vehicle, a hybrid electric vehicle or fuel cell vehicle). In another aspect of this particular embodiment, the composition comprises R1132a/R32/R1234yf at 5/44/51 or R1132(E)/R32/R1234yf at 32/44/24 (which is useful in a wide range of applications include applications wherein a GWP<300 is desired). In another aspect of this particular embodiment, the foregoing compositions can be employed for residential, commercial, and industrial space heating, water heating, among other applications where the boiling point of the compositions would enable low ambient temperature operation.

Another embodiment of the invention relates to any of the foregoing compositions wherein the at least one inhibitor is selected from the group consisting of terpenes, terpenoids, linear unsaturated hydrocarbons, and phenolics.

Another embodiment of the invention relates to any of the foregoing compositions wherein the at least one inhibitor is selected from the group consisting of D-limonene, terpinene, pinene, p-cymene, terpineol, myrcene, farnesene, 4-methoxyphenol, butylated hydroxytoluene, butylated hydroxyanisole, and tert-butylhydroquinone.

Another embodiment of the invention relates to any of the foregoing compositions wherein the at least one inhibitor is present in an amount in the range of about 5 ppm to about 3,000 ppm, about 50 to about 2,000 ppm and, in some cases about 75 to about 500 ppm.

Another embodiment of the invention relates to any of the foregoing compositions further comprising at least one lubricant.

Another embodiment of the invention relates to any of the foregoing compositions wherein the composition comprises less than about 0.03 wt % of oligomeric, homopolymers or other polymeric products.

Another embodiment of the invention relates to any of the foregoing compositions further comprising at least one initiator selected from the group consisting of air, oxygen, cumene hydroperoxide, fluoroolefin polyperoxides, peroxides, hydroperoxides, persulfates, percarbonates, perborates, and hydropersulfates.

Another embodiment of the invention relates to any of the foregoing compositions further comprising at least one antioxidant.

One particular embodiment relates to the at least one antioxidant being selected from the group consisting of butylated hydroxytoluene, butylated hydroxyanisole, tert-butylhydroquinone, gallate, 2-phenyl-2-propanol, 1-(2,4,5-trihydroxyl phenyl)-1-butanone, a phenolic, a bisphenol methane derivative, and 2,2′-methylenebis(4-methyl-6-t-butylphenol).

One embodiment of the invention relates to a composition comprising:
a. at least one fluoroethylene in an amount of at least 99.5%, by weight; vinyl fluoride (HFO-1141); and
b. at least one additional compound selected from the group consisting of chlorotrifluoromethane (CFC-13), trifluoromethane (CFC-23), difluoromethane (CFC-32), 1-chloro-1,1-difluoroethane (HFC-142b), 1,1,1-trifluoroethane (HFC-143a), tetrafluoroethylene (HFO-1114), 1-chloro-2,2-difluoroethylene (HFO-1122), acetylene, ethylene, 1,2-dichloro-1,2-difluoroethane (HFC-132), 1,1,2-trifluoroethane (HFC-143), 1-chloro-1,2-difluoroethylene (HFO-1122a), trifluoroethylene (HFO-1123), 1-chloro-2-fluoroethylene (HFO-1131), (Z)-1,2-difluoroethylene ((Z)-HFO-1132) and combinations thereof, in an amount of greater than 0 and, in some cases, at least 0.1% by weight.

One embodiment relates to the at least one fluoroethylene comprising at least one difluoroethylene.

One particular embodiment relates to the at least one difluoroethylene comprising 1,1-difluoroethylene (HFO-1132).

Another particular embodiment relates to the at least one additional compound being selected from the group consisting of chlorotrifluoromethane (CFC-13), trifluoromethane (HFC-23), difluoromethane (HFC-32), 1-chloro-1,1-difluoroethane (HCFC-142b), 1,1,1-trifluoroethane (HFC-143a), tetrafluoroethylene (HFO-1114), 1-chloro-2,2-difluoroethylene (HFO-1122), and combinations thereof.

Another particular embodiment relates to the at least one difluoroethylene comprising (E)-1,2-difluoroethylene.

Another particular embodiment relates to the at least one additional compound being selected from the group consisting of acetylene, ethylene, 1,2-dichloro-1,2-difluoroethane (HCFC-132), 1,1,2-trifluoroethane (HFC-143), 1,1,1-trifluoroethane (HFC-143a), 1-chloro-1,2-difluoroethylene (HFO-1122a), trifluoroethylene (HFO-1123), trifluoroethylene (HFO-1123), 1-chloro-2-fluoroethylene (HFO-1131), 1,2-difluoroethylene (HFO-Z-1132), and combinations thereof.

Another particular embodiment relates to any of the foregoing compositions with at least one additional compound comprising C2-C5 hydrocarbons including linear, branched and cyclic compounds. Examples of such additional compounds comprising at least one memer selected from the group consisting of propane, cyclopropane, propylene, isobutene, butane and butene.

Another embodiment of the invention relates to any of the foregoing compositions further comprising an effective amount of at least one inhibitor such that the composition is substantially free of oligomeric, homopolymers or other polymeric products derived from the fluoroethylene.

One particular embodiment relates to the at least one inhibitor being selected from the group consisting of terpenes, terpenoids, linear unsaturated hydrocarbons, and phenolics.

Another particular embodiment relates to the at least one inhibitor being present in an amount of about 30 ppm to about 3,000 ppm.

Another particular embodiment relates to the at least one inhibitor being selected from the group consisting of D-limonene, terpinene, pinene, p-cymene, terpineol, myrcene, farnesene, 4-methoxyphenol, butylated hydroxytoluene, butylated hydroxyanisole, and tert-butylhydroquinone.

Another particular embodiment relates to the composition comprising greater than 0 and less than about 0.03 wt % of oligomeric, homopolymers or other polymeric products.

One particular embodiment relates to the composition further comprising at least one member selected from the group consisting of air, oxygen, cumene hydroperoxide, and fluoroolefin polyperoxides, peroxides, hydroperoxides, persulfates, percarbonates, perborates, and hydropersulfates.

Another embodiment of the invention relates to any of the foregoing compositions further comprising at least one lubricant.

Another embodiment of the invention relates to any of the foregoing compositions comprising at least one fluoroethylene, at least one terpene inhibitor and one or more oxidation products, wherein the oxidation product is an oxidation product of a terpene inhibitor

One embodiment of the invention relates to a method for heating or cooling comprising:
a. condensing a refrigerant composition from a vapor phase to a liquid phase in a refrigerant loop, the refrigerant composition comprising at least one fluoroethylene and an effective amount of inhibitor wherein the effective amount is effective to reduce oligomer or homopolymer formation from the at least one fluoroethylene; and
b. thereafter evaporating said refrigerant composition from the liquid phase to the vapor phase in the refrigerant loop.

One particular embodiment relates to the method wherein the refrigerant composition has been exposed to at least one member selected from the group consisting of air, oxygen, cumene hydroperoxide, and fluoroolefin polyperoxides, peroxides, hydroperoxides, persulfates, percarbonates, perborates, and hydropersulfates before said contacting.

Another embodiment of the invention relates to any of the foregoing methods further comprising providing a lubricant to the refrigerant loop wherein the inhibitor is present in the liquid phase and the lubricant.

One particular embodiment of the method relates to the vapor phase being substantially free of the inhibitor.

One embodiment of the invention relates to a method for reducing formation of oligomers and homopolymers comprising:
contacting a composition comprising at least one fluoroethylene with an effective amount of at least one member selected from the group consisting of limomene, α-terpinene, α-tocopherol, butylated hydroxytoluene, 4-methoxyphenol, benzene-1,4-diol, meta-xylene, ortho-xylene, para-xylene, alpha-methylstyrene, alpha meta-methylstyrene, alpha ortho-methylstyrene, and alpha para-methylstyrene wherein the effective amount is effective to reduce oligomer or homopolymer formation from the at least one fluoroethylene.

Another embodiment of the invention relates to a container with a refrigerant comprising any of the foregoing compositions.

Another embodiment of the invention relates to a composition comprising at least one terpene and at least one oxidation product of the at least one terpene.

The embodiments of the invention can be used alone or in combinations with each other, and that different embodiments can be combined and form part of the invention.

### BRIEF DESCRIPTION OF THE DRAWINGS

FIGS. 1A, 1B and 1C are charts which respectively illustrate the refrigeration COP, Cap and Glide performance of compositions comprising 1234yf, 1132(E), 32 and 143a.

FIGS. 2A, 2B and 2C are charts which respectively illustrate the refrigeration COP, Cap and Glide performance of compositions comprising 1234yf, 1132(E), and 32 and can be employed under conditions similar to conventionally used R-404A.

FIGS. 3A, 3B and 3C are charts which respectively illustrate the refrigeration COP, Cap and Glide performance of compositions comprising 1234yf, 1132(E), and 32 and can be employed under conditions similar to conventionally used R-123.

### DETAILED DESCRIPTION OF THE INVENTION

In some embodiments, the present invention provides a stabilized composition comprising at least one fluoroethylene and an effective amount of at least one inhibitor. By “stabilized” it is meant to refer to a composition comprising an effective amount of at least one inhibitor compound that inhibits, if not eliminates a fluoroethylene from interacting with another compound and forming dimers, oligomers, homopolymers, or polymeric products. Examples of such compounds that can cause such interactions include oxidizers such as air, oxygen, cumene hydroperoxide, and fluoroolefin polyperoxides, peroxides, hydroperoxides, persulfates, percarbonates, perborates, and hydropersulfates, among other initiators. Initiator compounds can be present in an amount from about 10 to about 15,000 ppm by weight, about 1,000 to about 10,000 ppm and in some cases about 1,000 to about 3,000 ppm and in some cases 30 to 2,000 ppm. Such initiator compounds can be present as contaminants in at least one of conduits, lines, and other systems used for handling the fluoroethylene-containing compositions; packaging (containers), and a refrigeration, air-conditioning, or heat pump system. Without wishing to be bound by any theory or explanation it is believed that certain contaminants can function as radical initiators thereby causing the fluoroethylene to oligomerize, homopolymerize, or form other polymeric products.

In one embodiment of the invention, the inventive compositions are substantially free of oligomeric, homopolymers, or other polymeric products derived from the fluoroethylene. By “substantially free” it is meant that the composition contains greater than 0 and less than about 1 wt %, greater than 0 and less than about 0.07 wt %, greater than 0 and less than about 0.03 wt % and and in some cases about 0 ppm of such products, when measured by IR or NMR.

In another embodiment of the invention, the inventive compositions are substantially free of certain conventional inhibitor compounds, including sesquiterpene compounds such as at least one member selected from the group consisting of famesol; famesene; ionic liquids such as an ionic liquid including an anion selected from the group consisting of [CH₃CO₂]⁻, [HSO₄]⁻, [CH₃OSO₃]⁻, [C₂H₅OSO₃]⁻, [AlCl₄]⁻, [CO₃]²⁻, [HCO₃]⁻, [NO₂]⁻, [NO₃]⁻, [SO₄]²⁻, [PO₄]³⁻, [HPO₄]²⁻, [H₂PO₄]⁻, [HSO₃]⁻, and certain fluorinated anion where the fluorinated anion is selected from the group consisting of [BF₄]⁻, [PF₆]⁻, [SbF₆]⁻, [CF₃SO₃]⁻, [HCF₂CF₂SO₃]⁻, [CF₃HFCCF₂SO₃]⁻, [HCClFCF₂SO₃]⁻, [(CF₃SO₂)₂N]⁻, [(CF₃CF₂SO₂)₂N]⁻, [(CF₃SO₂)₃C]⁻, [CF₃CO₂]⁻, [CF₃OCFHCF₂SO₃]⁻, [CF₃CF₂OCFHCF₂SO₃]⁻, [CF₃CFHOCF₂CF₂SO₃]⁻, [CF₂HCF₂OCF₂CF₂SO₃]⁻, [CF₂ICF₂OCF₂CF₂SO₃]⁻, [CF₃CF₂OCF₂CF₂SO₃]⁻, [(CF₂HCF₂SO₂)₂N]⁻, [(CF₃CFHCF₂SO₂)₂N]⁻, and mixtures thereof. In one particular aspect of this embodiment, the composition is substantially free of phenols and compounds having phenol groups. By substantially free it is meant that the inventive compositions contains less than about 500 ppm, typically less than about 250 ppm, in some cases about 100 ppm, and in some cases about 0 ppm of such conventional inhibitors.

In one embodiment of the invention, the inventive composition comprises at least one fluoroethylene, at least one terpene inhibitor and one or more oxidation products, wherein the oxidation product is an oxidation product of a terpene inhibitor. The terpene inhibitor may be chosen from one or more of limonene, α-terpinene, α-pinene and β-pinene.

The oxidation product may be an oxidation product of limonene, chosen from at least one of carvone, carveol (Z- and E-) and limonene oxide (Z- and E-) as illustrated below.

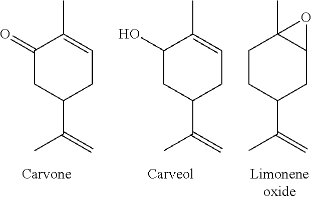

When the inhibitor comprises limonene, the composition may further comprise one or more of the following: α-terpene, cymene, 1-octanol, γ-terpinene, terpinolene, and β-terpinene.

The oxidation product may be an oxidation product of α-terpinene, chosen from at least one of 3-isopropyl-6-methyl-7-oxabicyclo[4.1.0]hept-2-ene, 6-isopropyl-3-methyl-7oxabicyclo[4.1.0]hept-2-ene, 1-isopropyl-4-methyl-cyclohex-2-ene-1,4-diol, E-3-isopropyl-6-methylhepta-2,6-dienal, p-cymene, and propane, all except propane as illustrated below.

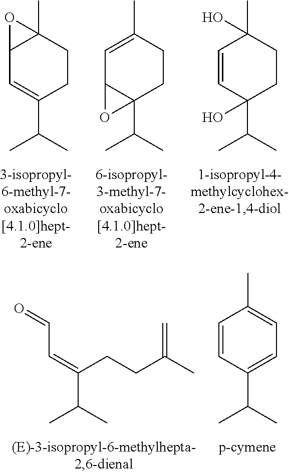

When the inhibitor comprises α-terpinene, the composition may further comprise one or more of the following: camphene, isocamphene, terpinolene, menthomenthene, phellandrene, sabinene, β-terpinene, 1,4-cineole, carvomenthene oxide, d-limonene, 1,8-cineol, γ-terpinene.

The oxidation product may be an oxidation product of α-pinene, wherein the oxidation product is α-pinene oxide, as illustrated below.

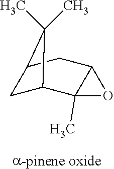

When the inhibitor comprises α-pinene, the composition may further comprise one or more of the following: 5-methyl-4-nonene, α-thujene, tricyclene (1,7,7-trimethyltricyclo[2.2.1.02,6]heptane), α-fenchene, camphene, cymene, d-limonene, α-campholenal.

The oxidation product may be an oxidation product of β-pinene, chosen from at least one of pinocarveol and myrtenol, as illustrated below.

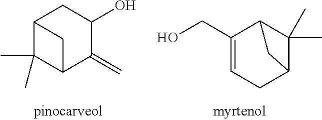

When the inhibitor comprises β-pinene, the composition may further comprise one or more of the following: α-pinene, α-fenchene, camphene, verbenene, myrcene, phellandrene, camphane, cymene and 2-menthene.

The composition disclosed herein comprises one or more oxidation products of a terpene inhibitor. The oxidation product may be chosen from one or more of carvone, carveol, limonene oxide, 3-isopropyl-6-methyl-7-oxabicyclo[4.1.0]hept-2-ene, 6-isopropyl-3-methyl-7-oxabicyclo[4.1.0]hept-2-ene, 1-isopropyl-4-methyl-cyclohex-2-ene-1,4-diol, E-3-isopropyl-6-methylhepta-2,6-dienal, p-cymene, propane, α-pinene oxide, pinocarveol and myrtenol.

When the inhibitor comprises limonene, the oxidation product may be at least one of carvone, carveol, and limonene oxide, as illustrated above. In one embodiment, when the inhibitor is limonene, the oxidation product is limonene oxide. In one embodiment, when the inhibitor is limonene, the oxidation product is carvone. In one embodiment, when the inhibitor is limonene, the oxidation product is carveol. In one embodiment, when the inhibitor is limonene, the oxidation product is two or more of limonene oxide, carvone and carveol.

When the inhibitor is α-terpinene, the oxidation product may be at least one of 3-isopropyl-6-methyl-7-oxabicyclo[4.1.0]hept-2-ene, 6-isopropyl-3-methyl-7oxabicyclo[4.1.0]hept-2-ene, 1-isopropyl-4-methyl-cyclohex-2-ene-1,4-diol, E-3-isopropyl-6-methylhepta-2,6-dienal, p-cymene and propane, all except propane, as illustrated above. In one embodiment, when the inhibitor is α-terpinene, the oxidation product is 3-isopropyl-6-methyl-7-oxabicyclo[4.1.0]hept-2-ene. In one embodiment, when the inhibitor is α-terpinene, the oxidation product is 6-isopropyl-3-methyl-7oxabicyclo[4.1.0]hept-2-ene. In one embodiment, when the inhibitor is α-terpinene, the oxidation product is 1-isopropyl-4-methyl-cyclohex-2-ene-1,4-diol. In one embodiment, when the inhibitor is α-terpinene, the oxidation product comprises E-3-isopropyl-6-methylhepta-2,6-dienal. In one embodiment, when the inhibitor is α-terpinene, the oxidation product comprises p-cymene. In one embodiment, when the inhibitor is α-terpinene, the oxidation product comprises propane. In one embodiment, when the inhibitor is α-terpinene, the oxidation product comprises a combination of two or more of 3-isopropyl-6-methyl-7-oxabicyclo[4.1.0]hept-2-ene, 6-isopropyl-3-methyl-7oxabicyclo[4.1.0]hept-2-ene, 1-isopropyl-4-methyl-cyclohex-2-ene-1,4-diol, E-3-isopropyl-6-methylhepta-2,6-dienal, p-cymene, and propane.

When the inhibitor comprises α-pinene, the oxidation product comprises α-pinene oxide, as illustrated above.

When the inhibitor comprises β-pinene, the oxidation product comprises at least one of pinocarveol and myrtenol, as illustrated above. In one embodiment, when the inhibitor comprises β-pinene, the oxidation product comprises pinocarveol. In one embodiment, when the inhibitor β-pinene, the oxidation product comprises myrtenol. In one embodiment, when the inhibitor is β-pinene, the oxidation product comprises pinocarveol and myrtenol.

While any suitable amount of oxidation product may be employed, effective amounts of an oxidation product comprise from 0.0001 wt % to 10 wt %, 0.01 wt % to 5 wt %, 0.3 wt % to 4 wt %, 0.3 wt % to 1 wt % based on the total weight of the composition. In one embodiment, an effective amount comprises 1 to 2000 ppm or 1 to 1000 ppm or 1 to 500 ppm of at least one oxidation product.

When two or more oxidation products are present, the total amount of oxidation product may also range from 0.0001 wt % to 10 wt %, 0.01 wt % to 5 wt %, 0.3 wt % to 4 wt %, 0.3 wt % to 1 wt % based on the total weight of the composition.

In some embodiments, the present invention provides a fluoroethylene compound comprising at least one fluoroethylene and at least one additional compound. In some embodiment, the at least one additional compound includes at least one fluoroolefin. In some embodiments, the at least one additional compound includes at least two additional compounds. In another embodiment, the at least one additional compound includes a hydrocarbon such as propane and butane.

The inventive compositions have a variety of utilities, including working fluids, which include blowing agents, solvents, aerosol propellants, fire extinguishants, sterilants or, heat transfer mediums (such as heat transfer fluids and refrigerants for use in refrigeration systems, refrigerators, air conditioning systems, heat pumps, chillers, and the like), among others. The inventive compounds are particularly suited for use in mobile air conditioning systems and as a component for making a refrigerant blend for use in stationary heat transfer systems.

A blowing agent is a volatile composition that expands a polymer matrix to form a cellular structure.

A solvent is a fluid that removes a soil from a substrate, or deposits a material onto a substrate, or carries a material.

An aerosol propellant is a volatile composition of one or more components that exerts a pressure greater than one atmosphere to expel a material from a container.

A fire extinguishant is a volatile composition that extinguishes or suppresses a flame.

A sterilant is a volatile biocidal fluid or blend containing a volatile biocidal fluid that destroys a biologically active material or the like.

A heat transfer medium (also referred to herein as a heat transfer fluid, a heat transfer composition or a heat transfer fluid composition) is a working fluid used to carry heat from a heat source to a heat sink.

A refrigerant is a compound or mixture of compounds that function as a heat transfer fluid in a cycle, where the fluid undergoes a phase change from a liquid to a gas (or vapor) and back. The inhibitor is present in at least the liquid fluoroethylene-containing phase of the refrigerant as well as a lubricant component of the refrigerant. In one embodiment, about 10 to about 80 wt %, about 25 to about 75 wt % and, in some cases, about 45 to about 60 wt % of the inhibitor is present in the liquid fluoroethylene-containing phase with the remainder predominantly present in the lubricant phase. In one embodiment, the vapor phase is substantially free of inhibitor. By “substantially free” it is meant that the amount of inhibitor in the vapor fluoroethylene-containing phase is less than about 10 ppm, in some cases less than about 5 and typically less than about 2 ppm. In one embodiment, the refrigerant comprises a vapor phase comprising at least one fluoroethylene and a liquid phase comprising at least one fluoroethylene, at least one lubricant, and at least one inhibitor and in some cases wherein the vapor phase is substantially free of the inhibitor. In other embodiments, the inhibitor is present in the vapor fluoroethylene-containing phase.

As used herein, the terms “comprises”, “comprising”, “includes”, “including”, “has”, “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim, such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method that includes materials, steps, features, components, or elements, in addition to those literally disclosed provided that these additional included materials, steps, features, components, or elements do materially affect the basic and novel characteristic(s) of the claimed invention, especially the mode of action to achieve the desired result of any of the processes of the present invention. The term “consisting essentially of” occupies a middle ground between “comprising” and “consisting of”.

Where applicants have defined an invention or a portion thereof with an open-ended term such as “comprising”, it should be readily understood that (unless otherwise stated) the description should be interpreted to also include such an invention using the terms “consisting essentially of” or “consisting of”.

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

The term fluoroethylene, as used herein, describes compounds which include two carbon atoms connected by a double bond and further include at least one fluorine atoms, optionally at least one hydrogen atom, and optionally at least one chlorine atom. In one embodiment, the fluoroethylene is of the formula CR₁R₂=CR₃R₄, where R₁ is fluorine and R₂, R₃, and R₄ are independently selected from hydrogen, fluorine, and chlorine. In one embodiment, the fluoroethylene is a hydrofluoroethylene. In one embodiment, the fluoroethylene is a difluoroethylene. In one embodiment, the difluoroethylene is (Z)-1,2-difluoroethylene (HFO-Z-1132). In one embodiment, the difluoroethylene is (E)-1,2-difluoroethylene (HFO-E-1132). In one embodiment, the difluoroethylene is 1,2-difluoroethylene (HFO-1132). In one embodiment, the difluoroethylene is 1,1-difluoroethylene (HFO-1132a). In another embodiment, the fluoroethylene comprises 1141 CFH═CH2)

In some embodiments, the composition includes at least 99.5 wt % of the fluoroethylene.

In some embodiments, the composition is a refrigerant blend including a fluoroethylene and at least one other compound. In some embodiments, the at least one other compound includes a fluoroolefin.

The term fluoroolefin, as used herein, describes compounds which comprise carbon atoms, fluorine atoms, and optionally hydrogen atoms. In one embodiment, the fluoroolefins used in the compositions of the present invention comprise compounds with 2 to 12 carbon atoms. In another embodiment the fluoroolefins comprise compounds with 3 to 10 carbon atoms, and in yet another embodiment the fluoroolefins comprise compounds with 3 to 7 carbon atoms.

Many of the compounds of the present compositions exist as different configurational isomers or stereoisomers. When the specific isomer is not designated, the present invention is intended to include all single configurational isomers, single stereoisomers, or any combination thereof. For instance, F11E is meant to represent the E-isomer, Z-isomer, or any combination or mixture of both isomers of 1,1,1,4,4,4-hexafluorobut-2-ene in any ratio. As another example, HFO-1132a is meant to represent the E-isomer, Z-isomer, or any combination or mixture of both isomers of 1,2-difluoroethylene in any ratio.

In one particular embodiment, the fluoroethylene component of an inventive composition comprises HFO-1132 and/or HFO-1132a. In another particular embodiment, the fluoroethylene comprises HFO-1132 and/or HFO-1132a having a purity of greater than 99 wt %, greater than 99.5 wt % pure, and in some cases greater than 99.5 to 99.98 wt % pure. In another particular embodiment, the fluoroethylene comprises at least 99.5 wt % of HFO-1132 and/or HFO-1132a and less than 0.5 and greater than 0.0001 wt % of the other fluoroethylene or another fluoroolefin, less than 0.3 and in some cases less than 0.2 wt %.

In some embodiments, the fluoroethylene component of an inventive composition or process is formed, purified, and/or obtained by a process known in the art.

In some embodiments, the fluoroethylene component is (E)-1,2-difluoroethylene formed and/or purified by a process described in U.S. Pat. App. Pub. No. 2021/0107850, which is hereby incorporated by reference.

In some embodiments, the fluoroethylene component is 1,1-difluoroethylene formed and/or purified by a process described in U.S. Pat. No. 7,294,747, which is hereby incorporated by reference.

In some embodiments, a composition comprises greater than about 99.5 wt % of a fluoroethylene component and vinyl fluoride (HFO-1141) and at least one additional compound selected from the group consisting of chlorotrifluoromethane (CFC-13), trifluoromethane (CFC-23), difluoromethane (CFC-32), 1-chloro-1,1-difluoroethane (HFC-142b), 1,1,1-trifluoroethane (HFC-143a), tetrafluoroethylene (HFO-1114), 1-chloro-2,2-difluoroethylene (HFO-1122), acetylene, ethylene, 1,2-dichloro-1,2-difluoroethane (HFC-132), 1,1,2-trifluoroethane (HFC-143), 1-chloro-1,2-difluoroethylene (HFO-1122a), trifluoroethylene (HFO-1123), 1-chloro-2-fluoroethylene (HFO-1131), (Z)-1,2-difluoroethylene ((Z)-HFO-1132), and combinations thereof. The amounts of the HFO-1141 and the at least one additional compound can range, by weight, from about 1 to about 2000 ppm, about 10 to about 1000 ppm, about 100 to about 500 ppm, about 50 to about 200 ppm, about 10 to about 100 ppm, greater than about 0.1%, or any value, range, or sub-range therebetween.

In some particular embodiments, the fluoroethylene component is 1,1-difluoroethylene (HFO-1132) and the at least one additional compound is selected from the group consisting of chlorotrifluoromethane (CFC-13), trifluoromethane (CFC-23), difluoromethane (CFC-32), 1-chloro-1,1-difluoroethane (HFC-142b), 1,1,1-trifluoroethane (HFC-143a), tetrafluoroethylene (HFO-1114), 1-chloro-2,2-difluoroethylene (HFO-1122), and combinations thereof.

In some particular embodiments, the fluoroethylene component is (E)-1,2-difluoroethylene ((E)-HFO-1132a) and the at least one additional compound is selected from the group consisting of acetylene, ethylene, 1,2-dichloro-1,2-difluoroethane (HFC-132), 1,1,2-trifluoroethane (HFC-143), 1,1,1-trifluoroethane (HFC-143a), 1-chloro-1,2-difluoroethylene (HFO-1122a), trifluoroethylene (HFO-1123), 1-chloro-2-fluoroethylene (HFO-1131), 1,2-difluoroethylene (HFO-Z-1132), and combinations thereof.

In some embodiments, the fluoroethylene component is 1,1-difluoroethylene in a refrigerant blend composition as described in International Pub. No. WO2020/035690A1 or International Pub. No. WO2020/135569A1, which is hereby incorporated by reference.

In some embodiments, the fluoroethylene component is (Z)-1,2-difluoroethylene in a refrigerant blend composition as described in U.S. Pat. No. 8,961,812, which is hereby incorporated by reference.

In some embodiments, the refrigerant blend includes fluoroethylene and at least one refrigerant compound selected from 2,3,3,3-tetrafluoropropene (HFO-1234yf), difluoromethane (HFC-32), 1,3,3,3-tetrafluoropropene (HFO-1234ze(E)), and 1,1-difluoroethane (HFC-152a). In some embodiments, the refrigerant blend further includes at least one refrigerant compound selected from trifluoroethylene (HFO-1123), trifluoroiodomethane (CF₃I), carbon dioxide (R-744, CO₂) and 1,1,1,2-tetrafluoroethane (HFC-134a).

In some embodiments, the refrigerant blend composition comprises from about 1 to about 96 wt % fluoroethylene and from about 4 wt % to about 99 wt % of at least one other refrigerant compound, alternatively about 1 to about 20 wt % fluoroethylene and from about 80 wt % to about 99 wt % of at least one other refrigerant compound, alternatively about 2 to about 14 wt % fluoroethylene and from about 86 wt % to about 98 wt % of at least one other refrigerant compound, alternatively about 20 wt % or greater fluoroethylene and up to about 80 wt % of at least one other refrigerant compound, alternatively about 72 to about 96 wt % fluoroethylene and from about 4 wt % to about 28 wt % of at least one other refrigerant compound, or any value, range, or sub-range therebetween.

In some particular embodiments, the refrigerant blend composition comprises from 2 to 14 wt % fluoroethylene, from 2 to 96 wt % of a second refrigerant compound, such as, for example, HFC-152a, and from 2 to 96 wt % of a third refrigerant compound, such as, for example, HFO-1234yf, such as, for example, from 4 to 10 wt % fluoroethylene, from 2 to 30 wt % of the second refrigerant compound, and from 60 to 94 wt % of the third refrigerant compound.

In some particular embodiments, the refrigerant blend composition comprises from 1 to 20 wt % fluoroethylene, from 1 to 21 wt % of a second refrigerant compound, such as, for example, HFC-32, and from 59 to 98 wt % of a third refrigerant compound, such as, for example, HFO-1234yf (e.g., as disclosed in WO2020/035690A1; the disclosure of which is hereby incorporated by reference).

In a further embodiment, the inventive inhibitor can be used with at least one of HFO-1132 and HFO-1132a, and compositions of blends comprising at least one of HFO-1132 and HFO-1132a.

Any suitable effective amount of inhibitor may be used in the foregoing compositions comprising at least one fluoroethylene. As described herein, the phrase “effective amount” refers to an amount of inhibitor of the present invention which, when added to a composition comprising at least one fluoroethylene, results in a composition wherein the fluoroethylene will not interact with an initiator, and/or degrade to produce as great a reduction in performance, for example, when stored in a high purity form, such as, for example, at least 99.5 wt %, or when in use as part of a refrigerant blend in a cooling apparatus as compared to the composition without an inhibitor. For cooling apparatus, such effective amounts of inhibitor may be determined by way of testing under the conditions of standard test ASHRAE 97-2007 (RA 2017). In a certain embodiment of the present invention, an effective amount may be said to be that amount of inhibitor that when combined with a composition comprising at least one fluoroethylene allows a cooling apparatus utilizing said composition comprising at least one fluoroethylene to perform at the same level of refrigeration performance and cooling capacity as if a composition comprising 1,1,1,2-tetrafluoroethane (R-134a), or other standard refrigerant (R-12, R-22, R-502, R-507A, R-508, R401A, R401B, R402A, R402B, R408, R-410A, R-404A, R407C, R-413A, R-417A, R-422A, R-422B, R-422C, R-422D, R-423, R-114, R-11, R-113, R-123, R-124, R236fa, or R-245fa) depending upon what refrigerant may have been used in a similar system in the past, were being utilized as the working fluid.

The instant invention employs effective amounts of at least one of the foregoing inhibitors. While any suitable effective amount can be employed, effective amounts comprise from about 0.001 weight percent to about 10 weight percent, about 0.01 weight percent to about 5 weight percent, about 0.3 weight percent to about 4 weight percent, about 0.3 weight percent to about 1 weight percent based on the total weight of compositions comprising at least one fluoroethylene containing compositions as described herein. In one embodiment, an effective amount comprises about 10 to about 2,000 ppm by weight, about 10 to about 1,000 ppm and in some cases about 10 to about 500 ppm of at least one inhibitor.

In one embodiment, an effective amount of inhibitor stabilizes the composition in the presence of about 10 to about 10,000 ppm by weight, about 10 to about 1,000 ppm, about 10 to about 500 ppm, and in some cases about 10 to about 100 ppm of at least one initiator.

One embodiment of the invention relates to any of the foregoing compositions and further comprises at least one anti-oxidant. While any suitable anti-oxidant can be employed, examples of suitable anti-oxidants include at least one member selected from the group consisting of butylated hydroxytoluene, butylated hydroxyanisole, tertiary-butylhydroquinone, gallate, 2-phenyl-2-propanol, 1-(2,4,5-trihydroxyphenyl)-1-butanone, phenolics, bisphenol methane derivatives, 2,2′-methylene bis (4-methyl-6-t-butyl phenol), and combinations thereof. The amount of anti-oxidant can range from about 0.01 to about 5,000 ppm by weight, about 0.03 to about 2000 ppm and in some cases about 0.05 to about 1000 ppm. An example of one particular embodiment relates to using the foregoing anti-oxidant with at least one inhibitor including α-terpinene or limonene. An example of one particular embodiment relates to using the foregoing anti-oxidant with an inhibitor comprising at least one of α-terpinene and limonene.

In one embodiment, the foregoing compositions of the present invention may further comprise at least one additional compound selected from the group consisting of fluoroolefins, hydrofluorocarbons, hydrocarbons, dimethyl ether, CF3I, ammonia, carbon dioxide (CO2), and mixtures thereof, meaning mixtures of any of the additional compounds listed in this paragraph. The amount of the additional compound can range from about 1 to about 90 wt %, about 5 to about 75 wt %, and in some cases about 10 to about 50 wt %.

In one embodiment, the additional compounds comprise hydrofluorocarbons. The hydrofluorocarbon (HFC) compounds of the present invention comprise saturated compounds containing carbon, hydrogen, and fluorine. Of particular utility are hydrofluorocarbons having 1-7 carbon atoms and having a normal boiling point of from about −90° C. to about 80° C. Hydrofluorocarbons are commercial products available from a number of sources, or may be prepared by methods known in the art. Representative hydrofluorocarbon compounds include but are not limited to fluoromethane (CH₃F, HFC-41), difluoromethane (CH₂F₂, HFC-32), trifluoromethane (CHF₃, HFC-23), pentafluoroethane (CF₃CHF₂, HFC-125), 1,1,2,2-tetrafluoroethane (CHF₂CHF₂, HFC-134), 1,1,1,2-tetrafluoroethane (CF₃CH₂F, HFC-134a), 1,1,1-trifluoroethane (CF₃CH₃, HFC-143a), 1,1-difluoroethane (CHF₂CH₃, HFC-152a), fluoroethane (CH₃CH₂F, HFC-161), 1,1,1,2,2,3,3-heptafluoropropane (CF₃CF₂CHF₂, HFC-227ca), 1,1,1,2,3,3,3-heptafluoropropane (CF₃CHFCF₃, HFC-227ea), 1,1,2,2,3,3-hexafluoropropane (CHF₂CF₂CHF₂, HFC-236ca), 1,1,1,2,2,3-hexafluoropropane (CF₃CF₃CH₂F, HFC-236cb), 1,1,1,2,3,3-hexafluoropropane (CF₃CHFCHF₂, HFC-236ea), 1,1,1,3,3,3-hexafluoropropane (CF₃CH₂CF₃, HFC-236fa), 1,1,2,2,3-pentafluoropropane (CHF₂CF₂CH₂F, HFC-245ca), 1,1,1,2,2-pentafluoropropane (CF₃CF₂CH₃, HFC-245cb), 1,1,2,3,3-pentafluoropropane (CHF₂CHFCHF₂, HFC-245ea), 1,1,1,2,3-pentafluoropropane (CF₃CHFCH₂F, HFC-245eb), 1,1,1,3,3-pentafluoropropane (CF₃CH₂CHF₂, HFC-245fa), 1,2,2,3-tetrafluoropropane (CH₂FCF₂CH₂F, HFC-254ca), 1,1,2,2-tetrafluoropropane (CHF₂CF₂CH₃, HFC-254cb), 1,1,2,3-tetrafluoropropane (CHF₂CHFCH₂F, HFC-254ea), 1,1,1,2-tetrafluoropropane (CF₃CHFCH₃, HFC-254eb), 1,1,3,3-tetrafluoropropane (CHF₂CH₂CHF₂, HFC-254fa), 1,1,1,3-tetrafluoropropane (CF₃CH₂CH₂F, HFC-254fb), 1,1,1-trifluoropropane (CF₃CH₂CH₃, HFC-263fb), 2,2-difluoropropane (CH₃CF₂CH₃, HFC-272ca), 1,2-difluoropropane (CH₂FCHFCH₃, HFC-272ea), 1,3-difluoropropane (CH₂FCH₂CH₂F, HFC-272fa), 1,1-difluoropropane (CHF₂CH₂CH₃, HFC-272fb), 2-fluoropropane (CH₃CHFCH₃, HFC-281ea), 1-fluoropropane (CH₂FCH₂CH₃, HFC-281fa), 1,1,2,2,3,3,4,4-octafluorobutane (CHF₂CF₂CF₂CHF₂, HFC-338pcc), 1,1,1,2,2,4,4,4-octafluorobutane (CF₃CH₂CF₂CF₃, HFC-338mf), 1,1,1,3,3-pentafluorobutane (CF₃CH₂CHF₂, HFC-365mfc), 1,1,1,2,3,4,4,5,5,5-decafluoropentane (CF₃CHFCHFCF₂CF₃, HFC-43-10mee), and 1,1,1,2,2,3,4,5,5,6,6,7,7,7-tetradecafluoroheptane (CF₃CF₂CHFCHFCF₂CF₂CF₃, HFC-63-14mee).

In another embodiment, the additional compounds comprise hydrocarbons. The hydrocarbons of the present invention comprise compounds having only carbon and hydrogen. Of particular utility are compounds having 3-7 carbon atoms. Hydrocarbons are commercially available through numerous chemical suppliers. Representative hydrocarbons include but are not limited to propane, n-butane, isobutane, cyclobutane, n-pentane, 2-methylbutane, 2,2-dimethylpropane, cyclopentane, n-hexane, 2-methylpentane, 2,2-dimethylbutane, 2,3-dimethylbutane, 3-methylpentane, cyclohexane, n-heptane, and cycloheptane.

In another embodiment, additional compounds comprise hydrocarbons containing heteroatoms, such as dimethylether (DME, CH₃OCH₃). DME is commercially available.

In another embodiment, additional compounds comprise iodotrifluoromethane (CF₃I), which is commercially available from various sources or may be prepared by methods known in the art.

In another embodiment, additional compounds comprise carbon dioxide (CO₂), which is commercially available from various sources or may be prepared by methods known in the art.

In another embodiment, additional compounds comprise at least one member selected from the group of HFC-23, HFC-41, HFC-134a, HCFC-22, CFC-12, HCC-40, and 143a.

In another embodiment, additional compounds comprise at least one member selected from the group of water, air (N2/O2 78/21 ratio), air (N2/O2 >78/21 ratio), O2, N2, Ar, CO2, CH4, and He.

In a specific aspect of the foregoing embodiment, the additional compound can comprise a tracer. While any suitable tracer can be employed, examples of suitable tracers comprise at least one member selected from the group consisting of as tracer: E-1336mzz, 1233zd, 1224yd, 1112, 1327, Z-1336mzz, 1336yf, 1336ze, and 263fb.

In another embodiment, the foregoing compositions of the present invention are substantially free of additional compounds and, in particular, substantially free of at least one of dimethyl ether, CF₃I, ammonia, and carbon dioxide. In one preferred aspect of this embodiment, the foregoing compositions are substantially free of CF₃I. By “substantially free of additional compounds”, it is meant that the compositions as well as the inhibitor comprise less than about 10%, usually less than about 5% and in some cases 0% of the additional compounds.

Of particular note are fluoroethylene compositions further comprising vinyl fluoride (HFO-1141) and at least one additional compound selected from chlorotrifluoromethane (CFC-13), trifluoromethane (CFC-23), difluoromethane (CFC-32), 1-chloro-1,1-difluoroethane (HFC-142b), 1,1,1-trifluoroethane (HFC-143a), tetrafluoroethylene (HFO-1114), 1-chloro-2,2-difluoroethylene (HFO-1122), acetylene, ethylene, 1,2-dichloro-1,2-difluoroethane (HFC-132), 1,1,2-trifluoroethane (HFC-143), 1-chloro-1,2-difluoroethylene (HFO-1122a), trifluoroethylene (HFO-1123), 1-chloro-2-fluoroethylene (HFO-1131), and (Z)-1,2-difluoroethylene ((Z)-HFO-1132).

In other embodiments of the invention, the fluoroethylene comprises at least about 99 mass % fluoroethylene and greater than 0 but less than 1 mass % of vinyl fluoride (HFO-1141) and at least one member selected from chlorotrifluoromethane (CFC-13), trifluoromethane (CFC-23), difluoromethane (CFC-32), 1-chloro-1,1-difluoroethane (HFC-142b), 1,1,1-trifluoroethane (HFC-143a), tetrafluoroethylene (HFO-1114), and 1-chloro-2,2-difluoroethylene (HFO-1122).

In other embodiments of the invention, the fluoroethylene comprises at least about 99 mass % fluoroethylene and greater than 0 but less than 1 mass % of vinyl fluoride (HFO-1141) and at least one member selected from acetylene, ethylene, 1,2-dichloro-1,2-difluoroethane (HFC-132), 1,1,2-trifluoroethane (HFC-143), 1,1,1-trifluoroethane (HFC-143a), 1-chloro-1,2-difluoroethylene (HFO-1122a), trifluoroethylene (HFO-1123), 1-chloro-2-fluoroethylene (HFO-1131), and 1,2-difluoroethylene (HFO-Z-1132).

In other embodiments of the invention, a refrigerant blend comprises one or more of the foregoing fluoroethylenes that are blended with at least one hydrofluorocarbon. Examples of suitable hydrofluorocarbons comprise at least one member selected from the group consisting of HFC-32, HFC-125, HFC-134a, HFC-152a, HFC-236fa, and HFC-227ea. The amount of hydrofluorocarbon can range from about 25 to about 75 wt %, about 30 to about 60 wt %, and in some cases about 30 to about 50 wt %.

If desired, the blended composition can further comprise at least one additional member selected from the group consisting of HCC-40, HCFC-22, CFC-115, HCFC-124, HCFC-1122, and CFC-1113. The amount of the additional member can comprise greater than 0 to about 5 wt %, about 0 to about 2 wt % and in some cases about 0 to about 0.5 wt %. In one particular embodiment, the foregoing amounts of additional members are blended with at least one of HFO-1132 and HFO-1132a. In another particular embodiment, the foregoing amounts of additional members are blended with at least one of HFO-1132 and HFO-1132a and at least one hydrofluorocarbon selected from the group consisting of HFC-32, HFC-125, HFC-134a, HFC-152a, 236fa and HFC-227ea, and in some cases, combined with carbon dioxide.

### Lubricants

In one embodiment, the foregoing compositions of the present invention may further comprise at least one lubricant. Lubricants of the present invention comprise those suitable for use with refrigeration or air-conditioning apparatus. Among these lubricants are those conventionally used in compression refrigeration apparatus utilizing chlorofluorocarbon refrigerants. Such lubricants and their properties are discussed in the 1990 ASHRAE Handbook, Refrigeration Systems and Applications, chapter 8, titled “Lubricants in Refrigeration Systems”, pages 8.1 through 8.21, herein incorporated by reference. Lubricants of the present invention may comprise those commonly known as “mineral oils” in the field of compression refrigeration lubrication. Mineral oils comprise paraffins (i.e. straight-chain and branched-carbon-chain, saturated hydrocarbons), naphthenes (i.e. cyclic or ring structure saturated hydrocarbons, which may be paraffins) and aromatics (i.e. unsaturated, cyclic hydrocarbons containing one or more rings characterized by alternating double bonds). Lubricants of the present invention further comprise those commonly known as “synthetic oils” in the field of compression refrigeration lubrication. Synthetic oils comprise alkylaryls (i.e. linear and branched alkyl alkylbenzenes), synthetic paraffins and naphthenes, silicones, and poly-alpha-olefins. Representative conventional lubricants of the present invention are the commercially available BVM 100 N (paraffinic mineral oil sold by BVA Oils), naphthenic mineral oil commercially available under the trademark from Suniso® 3GS and Suniso® 5GS by Crompton Co., naphthenic mineral oil commercially available from Pennzoil under the trademark Sontex® 372LT, naphthenic mineral oil commercially available from Calumet Lubricants under the trademark Calumet® RO-30, linear alkylbenzenes commercially available from Shrieve Chemicals under the trademarks Zerol® 75, Zerol® 150 and Zerol® 500 and branched alkylbenzene, sold by Nippon Oil as HAB 22.

In another embodiment, lubricants of the present invention comprise those which have been designed for use with hydrofluorocarbon refrigerants and are miscible with refrigerants of the present invention under compression refrigeration and air-conditioning apparatus' operating conditions. Such lubricants and their properties are discussed in “Synthetic Lubricants and High-Performance Fluids”, R. L. Shubkin, editor, Marcel Dekker, 1993. Such lubricants include, but are not limited to, polyol esters (POEs) such as Castrol® 100 (Castrol, United Kingdom), polyalkylene glycols (PAGs) such as RL-488A from Dow (Dow Chemical, Midland, Michigan), and polyvinyl ethers (PVEs).

Lubricants of the present invention are selected by considering a given compressor's requirements and the environment to which the lubricant will be exposed. The amount of lubricant can range from about 1 to about 50 wt %, about 1 to about 20 wt %, and in some cases about 1 to about 3 wt %. In one particular embodiment, the foregoing compositions are combined with a PAG lubricant for usage in an automotive A/C system having an internal combustion engine. In another particular embodiment, the foregoing compositions are combined with a POE lubricant for usage in an automotive A/C system having an electric or hybrid electric drive train.

In embodiments including a refrigerant composition further comprising an inhibitor and a lubricant, the inhibitor may be present in the liquid phase of the refrigerant composition, in the vapor phase of the refrigerant composition, and/or in the lubricant. In one embodiment of the invention, the inhibitor partitions between the two liquid phases, namely, the liquid phase fluoroolefin and the lubricant. The amount of inhibitor present in the liquid phase of the fluoroolefin can range about 10 to about 80 wt %, about 25 to about 75 wt % and, in some cases, about 45 to about 60 wt % of the inhibitor with the remainder of the inhibitor predominantly present in the lubricant phase.

In exemplary embodiments, the inhibitor has sufficient miscibility in the lubricant such that a portion of the inhibitor is present within the lubricant. The amount of inhibitor present in the lubricant may vary when the refrigerant composition is employed as a working fluid or heat transfer medium.

### Additives

In one embodiment of the invention, in addition to the inventive inhibitor, the composition can comprise at least one additive which can improve the refrigerant and air-conditioning system lifetime and compressor durability are desirable. In one aspect of the invention, the foregoing compositions comprise at least one member selected from the group consisting of acid scavengers, performance enhancers, and flame suppressants.

Additives which can improve the refrigerant and A/C lifetime and compressor durability are desirable. In one aspect of the invention, the inventive refrigerant containing composition is used to introduce lubricant into the A/C system as well as other additives, such as a) acid scavengers, b) performance enhancers, and c) flame suppressants.

An acid scavenger may comprise a siloxane, an activated aromatic compound, or a combination of both. Serrano et al. (paragraph 38 of US 2011/0272624 A1), which is hereby incorporated by reference, discloses that the siloxane may be any molecule having a siloxyfunctionality. The siloxane may include an alkyl siloxane, an aryl siloxane, or a siloxane containing mixtures of aryl and alkyl substituents. For example, the siloxane may be an alkyl siloxane, including a dialkylsiloxane or a polydialkylsiloxane. Preferred siloxanes include an oxygen atom bonded to two silicon atoms, i.e., a group having the structure: SiOSi. For example, the siloxane may be a siloxane of Formula IV: R1[Si(R2R3)4O]nSi(R2R3)R4, Where n is 1 or more. Siloxanes of Formula IV have n that is preferably 2 or more, more preferably 3 or more, (e.g., about 4 or more). Siloxanes of formula IV have n that is preferably about 30 or less, more preferably about 12 or less, and most preferably about 7 or less. Preferably the R4 group is an aryl group or an alkyl group. Preferably the R2 groups are aryl groups or alkyl groups or mixtures thereof. Preferably the R3 groups are aryl groups or alkyl groups or mixtures thereof. Preferably the R4 group is an aryl group or an alkyl group. Preferably R1, R2, R3, R4, or any combination thereof are not hydrogen. The R2 groups in a molecule may be the same or different. Preferably the R2 groups in a molecule are the same. The R2 groups in a molecule may be the same or different from the R3 groups. Preferably, the R2 groups and R3 groups in a molecule are the same. Preferred siloxanes include siloxanes of Formula IV, wherein R1, R2, R3, R4, R5, or any combination thereof is a methyl, ethyl, propyl, or butyl group, or any combination thereof. Exemplary siloxanes that may be used include hexamethyldisiloxane, polydimethylsiloxane, polymethylphenylsiloxane, dodecamethylpentasiloxane, decamethylcyclo-pentasiloxane, decamethyltetrasiloxane, octamethyltrisiloxane, or any combination thereof.

Incorporated by reference from Serrano et al., paragraph notes that in one aspect of the invention, the siloxane is an alkylsiloxane containing from about 1 to about 12 carbon atoms, such as hexamethyldisiloxane. The siloxane may also be a polymer such as polydialkylsiloxane, where the alkyl group is a methyl, ethyl, propyl, butyl, or any combination thereof. Suitable polydialkylsiloxanes have a molecular weight from about 100 to about 10,000. Highly preferred siloxanes include hexamethyldisiloxane, polydimethylsiloxane, and combinations thereof. The siloxane may consist essentially of polydimethylsiloxane, hexamethyldisoloxane, or a combination thereof.

The activated aromatic compound may be any aromatic molecule activated towards a Friedel-Crafts addition reaction, or mixtures thereof. An aromatic molecule activated towards a Friedel-Crafts addition reaction is defined to be any aromatic molecule capable of an addition reaction with mineral acids. Especially aromatic molecules capable of addition reactions with mineral acids either in the application environment (A/C system) or during the ASHRAE 97: 2007 “Sealed Glass Tube Method to Test the Chemical Stability of Materials for Use within Refrigerant Systems” thermal stability test. Such molecules or compounds are typically activated by substitution of a hydrogen atom of the aromatic ring with one of the following groups: —NH₂, —NHR, —NRz, ADH, AD, —NHCOCH₃, —NHCOR, 4OCH₃, —OR, —CH₃, 4C₂H₅, —R, or —C₆H₅, where R is a hydrocarbon (preferably a hydrocarbon containing from about 1 to about 100 carbon atoms). The activated aromatic molecule may be an alcohol, or an ether, where the oxygen atom (i.e., the oxygen atom of the alcohol or ether group) is bonded directly to an aromatic group. The activated aromatic molecule may be an amine Where the nitrogen atom (i.e., the nitrogen atom of the amine group) is bonded directly to an aromatic group. By way of example, the activated aromatic molecule may have the formula ArXRn, Where X is O (i.e., oxygen) or N (i.e., nitrogen); n:1 When X:O; n:2 When x:N; Ar is an aromatic group (i.e., group, C6H5); R may be H or a carbon containing group; and when n:2, the R groups may be the same or different. For example, R may be H (i.e., hydrogen), Ar, an alkyl group, or any combination thereof, Exemplary activated aromatic molecules that may be employed in a refrigerant composition according to the teachings herein include diphenyl oxide (i.e., diphenyl ether), methyl phenyl ether (e.g., anisole), ethyl phenyl ether, butyl phenyl ether or any combination thereof. One highly preferred aromatic molecule activated to Wards a Friedel-Crafts addition reaction is diphenyl oxide.

Incorporated by reference from Serrano et al. paragraph [0045] The acid scavenger (e.g., the activated aromatic compound, the siloxane, or both) may be present in any concentration that results in a relatively low total acid number, a relatively low total halides concentration, a relatively low total organic acid concentration, or any combination thereof. Preferably the acid scavenger is present at a concentration greater than about 0.0050 wt %, more preferably greater than about 0.05 wt % and even more preferably greater than about 0.1 wt % (e.g. greater than about 0.5 wt %) based on the total Weight of the refrigerant composition. The acid scavenger preferably is present in a concentration less than about 3 wt %, more preferably less than about 2.5 wt % and most preferably greater than about 2 wt % (e. g. less than about 1.8 wt %) based on the total Weight of the refrigerant composition.

Additional examples of acid scavengers which may be included in the refrigerant composition and preferably are excluded from the refrigerant composition include those described by Kaneko (U.S. patent application Ser. No. 11/575,256, published as U.S. Patent Publication 2007/0290164, paragraph 42, expressly incorporated herein by reference), such as one or more of: phenyl glycidyl ethers, alkyl glycidyl ethers, alkyleneglycolglycidylethers, cyclohexeneoxides, otolenoxides, or epoxy compounds such as epoxidized soybean oil, and those described by Singh et al. (U.S. patent application Ser. No. 11/250,219, published as 20060116310, paragraphs 34-42, expressly incorporated herein by reference).

Preferred additives include those described in U.S. Pat. Nos. 5,152,926; 4,755,316, which are hereby incorporated by reference. In particular, the preferred extreme pressure additives include mixtures of (A) tolyltriazole or substituted derivatives thereof, (B) an amine (e.g. Jeffamine M-600) and (C) a third component which is (i) an ethoxylated phosphate ester (e.g. Antara LP-700 type), or (ii) a phosphate alcohol (e.g. ZELEC 3337 type), or (iii) a Zinc dialkyldithiophosphate (e.g. Lubrizol 5139, 5604, 5178, or 5186 type), or (iv) a mercaptobenzothiazole, or (v) a 2,5-dimercapto-1,3,4-triadiaZole derivative (e. g. Curvan 826) or a mixture thereof. Additional examples of additives which may be used are given in U.S. Pat. No. 5,976,399 (Schnur, 5:12-6:51, hereby incorporated by reference).

Acid number is measured according to ASTM D664-01 in units of mg KOH/g. The total halides concentration, the fluorine ion concentration, and the total organic acid concentration is measured by ion chromatography. Chemical stability of the refrigerant system is measured according to ASHRAE 97: 2007 (RA 2017) “Sealed Glass Tube Method to Test the Chemical Stability of Materials for Use within Refrigerant Systems”. The viscosity of the lubricant is tested at 40° C. according to ASTM D-7042.

Mouli et al. (WO 2008/027595 and WO 2009/042847) teach the use of alkyl silanes as a stabilizer in refrigerant compositions containing fluoroethylenes. Phosphates, phosphites, epoxides, and phenolic additives also have been employed in certain refrigerant compositions. These are described for example by Kaneko (U.S. Pat. App. Pub. No. 2007/0290164) and Singh et al. (U.S. Pat. App. Pub. No. 2006/0116310). All of these aforementioned applications are expressly incorporated herein by reference.

Preferred flame suppressants include those described in Canadian Pat. No. 2,557,873, entitled “Compositions containing fluorine substituted olefins” and incorporated by reference along with fluorinated products such as HFC-125 and/or Krytox® lubricants described in International Pub. No. WO2009/018117A1, entitled “Compositions comprising fluoroolefins and uses thereof”, which is also incorporated by reference.

The compositions of the present invention may be prepared by any convenient method to combine the desired amount of the individual components. A preferred method is to weigh the desired component amounts and thereafter combine the components in an appropriate vessel. Agitation may be used, if desired.

The present invention further relates to a process for producing cooling comprising condensing a composition comprising at least one fluoroethylene and an effective amount of inhibitor, and thereafter evaporating said composition in the vicinity of a body to be cooled.

A body to be cooled may be any space, location, or object requiring refrigeration or air-conditioning. In stationary applications, the body may be the interior of a structure, i.e. residential or commercial, or a storage location for perishables, such as food or pharmaceuticals. For mobile refrigeration applications, the body may be incorporated into a transportation unit for the road, rail, sea or air. Certain refrigeration systems operate independently with regards to any moving carrier and are known as “intermodal” systems. Such intermodal systems include “containers” (combined sea/land transport) as well as “swap bodies” (combined road and rail transport).

The present invention further relates to a process for producing heat comprising condensing a composition comprising at least one fluoroethylene and an effective amount of an inhibitor comprising at least one of limonene and α-terpinene in the vicinity of a body to be heated, and thereafter evaporating said composition.

A body to be heated may be any space, location, or object requiring heat. These may be the interior of structures either residential or commercial in a similar manner to the body to be cooled. Additionally, mobile units as described for cooling may be similar to those requiring heating. Certain transport units require heating to prevent the material being transported from solidifying inside the transport container.

Another embodiment of the invention relates to an air-conditioning or refrigeration apparatus comprising the foregoing compositions.

Another embodiment of the invention relates to storing the foregoing compositions in gaseous and/or liquid phases within a sealed container where the oxygen and/or water concentration in the gas and/or liquid phases ranges from about 3 vol ppm up to less than about 3,000 vol ppm at a temperature of about 25° C., about 5 vol ppm up to less than about 1,000 vol ppm, and in some cases about 5 vol ppm up to less than about 500 vol ppm.

The container for storing the foregoing compositions can be constructed of any suitable material and design that is capable of sealing the compositions therein while maintaining gaseous and liquids phases. Examples of suitable containers comprise pressure-resistant containers such as a tank, a filling cylinder, and a secondary filing cylinder. The container can be constructed from any suitable material such as carbon steel, manganese steel, or chromium-molybdenum steel, among other low-alloy steels, stainless steels, and in some cases aluminum alloys. The container can include a pierce top or valves suitable for dispensing flammable substances.

While any suitable method can be employed for stabilizing fluorocarbon-containing compositions, examples of such methods include blending the foregoing inhibitors with the foregoing fluoroethylene composition and purging lines and containers with a material comprising the inhibitor (e.g., an inhibitor with a nitrogen carrier, or the inventive stabilized composition), among other suitable methods.

In one embodiment, the inventive composition is prepared by adding the inhibitor to at least one of the fluoroethylene component and the lubricant, and then combining the fluoroethylene component with the lubricant. In the event that the inhibitor is added to only one of the fluoroethylene or lubricant and then the fluoroethylene and lubricant are combined, the inhibitor will partition such that the inhibitor becomes present in the fluoroethylene and lubricant. In another embodiment, the inhibitor can be added to a composition comprising at least one fluoroethylene component and at least one lubricant.

Another embodiment of the invention relates to storing the foregoing compositions in gaseous and/or liquid phases within a sealed container wherein the oxygen and/or water concentration in the gas and/or liquid phases ranges from about 3 vol ppm to less than about 3,000 vol ppm at a temperature of about 25° ° C., about 5 vol ppm to less than about 1,000 vol ppm and in some cases about 5 vol ppm to less than about 500 vol ppm and all values therebetween.

The container for storing the foregoing compositions can be constructed of any suitable material and design that is capable of sealing the compositions therein while maintaining gaseous and liquids phases. Examples of suitable containers comprise pressure resistant containers such as a tank, a filling cylinder, and a secondary filing cylinder. The container can be constructed from any suitable material such as carbon steel, manganese steel, chromium-molybdenum steel, among other low-alloy steels, stainless steel and in some case an aluminum alloy. The container can include a pierce top or valves suitable for dispensing flammable substances.

### EXAMPLES

The following examples are provided to illustrate certain embodiments of the invention and shall not limit the scope of the appended claims.

### Example 1

For Control 1, a rock bomb was evacuated and then blanketed with nitrogen gas (N₂). 0.2 g of initiator (azobisisobutyronitrile, AIBN) was then placed in the rock bomb. The rock bomb was then evacuated and filled with a test composition 200 g of HFO-1132a (having at least 99.5 wt % purity) and 0.1% AIBN initiator (with no inhibitor). The rock bomb was then heated at the temperature and for the period of time given in Table 1. The rock bomb was visually inspected for polymer formation as well as by using IR in accordance with conventional methods by detecting HFO-1132a polymer peaks. Polymer can also be detected by using conventional NMR methods.

For Examples 1-3, the test composition included 200 g of HFO-1132 or HFO-1132a (having at least 99.5 wt % purity), 0.1% AIBN initiator, and the amount of d-limonene listed in Table 1 as an inhibitor.

Table 1 shows that about 3.7 wt % of the fluoroethylene polymerized without an inhibitor under the test conditions for Control 1. Addition of 500 ppm of d-limonene as an inhibitor in Example 1 reduced the amount of polymerization of the fluoroethylene to 0.25 wt %. Addition of 1500 ppm and 3000 ppm of d-limonene as an inhibitor in Examples 2 and 3, respectively, further reduced the amount of polymerization of the fluoroethylene to less than 0.1 wt %.

TABLE 1

| | | concen. | | | | T | polymer |
|---|---|---|---|---|---|---|---|
| Example | Inhibitor | (ppm) | | Initiator | time | (° C.) | (wt %) |
| Control 1 | None | — | | AlBN (0.1%) | 15 hr | 90 | 3.7 |
| 1 | d-limonene | 500 | ppm | AlBN (0.1%) | 15 hr | 90 | 0.25 |
| 2 | d-limonene | 1500 | ppm | AlBN (0.1%) | 15 hr | 90 | <0.1 |
| 3 | d-limonene | 3000 | ppm | AlBN (0.1%) | 15 hr | 90 | <0.1 |
| Control 2 | None | — | | (NH₄)₂S₂O₈ (1.5%) | 15 hr | 90 | 90 |
| 4 | d-limonene | 8000 | ppm | (NH₄)₂S₂O₈ (1.5%) | 15 hr | 100 | <0.1 |

For Control 2, 40 g of HFO-1132a (having at least 99.5 wt % purity) was added to 200 mL of deionized water containing 0.6 g ammonium persulfate as an initiator and 0.6 g of a fluorosurfactant. The mixture was stirred at the temperature and for the period of time given in Table 1.

For Example 4, the test sample included 40 g of HFO-1132a (having at least 99.5 wt % purity) added to 200 mL of deionized water containing 0.6 g ammonium persulfate as an initiator, 0.6 g of a fluorosurfactant, and 0.34 g (8000 ppm) d-limonene as an inhibitor.

Table 1 shows that about 90 wt % of the fluoroethylene polymerized without an inhibitor under the test conditions for Control 2. Addition of 8000 ppm of d-limonene as an inhibitor in Example 4 stabilized the refrigerant blend and reduced the amount of polymerization of the fluoroethylene to less than 0.1 wt %.

### Example 2

For Control 3, 30 g of HFO-1132a (having at least 99.5 wt % purity) and 3300 ppm of the initiator (air) was added to a shaker tube. The shaker tube was maintained at the temperature and for the period of time given in Table 2. The shaker tube was then cooled to room temperature and examined for polymer formation.

For Examples 5-7, the mixture also includes the amount of d-limonene or α-terpinene listed in Table 2 as an inhibitor.

Table 2 shows that greater than 3 wt % of the fluoroethylene polymerized without an inhibitor under the test conditions for Control3. Inclusion of the inhibitor in the amounts listed for Examples 5-7 for the conditions listed in Table 2 is expected to stabilize the refrigerant blend and reduce the amount of polymerization of the fluoroethylene to less than 0.1 wt %.

TABLE 2

| | | concen. | | | | | T | polymer |
|---|---|---|---|---|---|---|---|---|
| Example | Inhibitor | (ppm) | | Initiator | time | | (° C.) | (wt %) |
| Control 3 | None | — | | air (3300 ppm) | 2 | wks | 100 | >3 |
| 5 | d-limonene | 500 | ppm | air (3300 ppm) | 2 | wks | 100 | <0.1 |
| 6 | d-limonene | 1500 | ppm | air (3300 ppm) | 2 | wks | 100 | <0.1 |
| 7 | α-terpinene | 3000 | ppm | air (3300 ppm) | 2 | wks | 100 | <0.1 |
| Control 4 | None | — | | air (10000 ppm) | 2 | wks | 100 | >10 |
| 8 | d-limonene | 500 | ppm | air (10000 ppm) | 2 | wks | 100 | <1 |
| 9 | d-limonene | 1000 | ppm | air (10000 ppm) | 2 | wks | 100 | <1 |
| 10 | α-terpinene + | 1000 | ppm | air (10000 ppm) | 2 | wks | 100 | <1 |
| | BHT | | | | | | | |
| Control 5 | None | — | | cumene hydroperoxide | 3 | days | 50 | >3 |
| | | | | (1700 ppm) | | | | |
| 11 | d-limonene | 3000 | ppm | cumene hydroperoxide | 3 | days | 50 | <0.1 |
| | | | | (1700 ppm) | | | | |
| 12 | α-terpinene | 3000 | ppm | cumene hydroperoxide | 3 | days | 50 | <0.1 |
| | | | | (1700 ppm) | | | | |

For Control 4, 30 g of HFO-1132a (having at least 99.5 wt % purity) and 10000 ppm of the initiator (air) is added to a shaker tube. The shaker tube is maintained at the temperature and for the period of time given in Table 2.

For Examples 8-10, the mixture also includes the amount of inhibitor listed in Table 2.

Greater than 10 wt % of the fluoroethylene is expected to polymerize without an inhibitor under the test conditions for Control 4. Inclusion of the inhibitor in the amounts listed for Examples 8-10 for the conditions listed in Table 2 is expected to stabilize the refrigerant blend and reduce the amount of polymerization of the fluoroethylene to less than 1 wt %.

For Control 5, 30 g of HFO-1132a (having at least 99.5 wt % purity) and 1700 ppm of the initiator (cumene hydroperoxide) is added to a 210-mL shaker tube. The shaker tube is maintained at the temperature and for the period of time given in Table 2.

For Examples 11-12, the mixture also includes the amount of inhibitor listed in Table 2.

Greater than 3 wt % of the fluoroethylene is expected to polymerize without an inhibitor under the test conditions for Control 5. Inclusion of the inhibitor in the amounts listed for Examples 11-12 for the conditions listed in Table 2 is expected to stabilize the refrigerant blend and reduce the amount of polymerization of the fluoroethylene to less than 0.1 wt %.

### Example 3

For Control 6, refrigerant blend comprising a mixture of (E)-HFO-1132, HFC-32, and HFO-1234yf (30 g) (i.e., corresponding to 32 wt % 1132, 44.2 wt. % HFC-32 and 23.8 wt. % 1234yf) and 2000 ppm of the initiator (air) is added to a 210-mL shaker tube. The shaker tube is maintained at the temperature and for the period of time given in Table 3.

For Examples 13-18, the inhibitor and the lubricant listed in Table 3 are added to the same refrigerant blend and initiator as in Control 6 in a 210-mL shaker tube. The shaker tube is maintained at the temperature and for the period of time given in Table 3.

Greater than 0.5 wt % of the refrigerant is expected to polymerize without an inhibitor under the test conditions for Control 7. Inclusion of the inhibitor in the amounts listed for Examples 13-18 for the conditions listed in Table 3 is expected to stabilize the refrigerant blend and produce no detectable amount of polymerization of the refrigerant.

TABLE 3

| | Inhibitor | Lubricant | Initiator | | T | Polymer |
|---|---|---|---|---|---|---|
| Example | (ppm) | (wt %) | (ppm) | Time | (° C.) | (wt %) |
| Control 6 | None | None | air (2000) | 2 weeks | 135 | >0.5 |
| 13 | d-limonene | POE32-3MAF (3) | air (2000) | 2 weeks | 135 | N/D |
| | (200) | | | | | |
| 14 | α-terpinene | POE32-3MAF (3) | air (2000) | 2 weeks | 135 | N/D |
| | (200) | | | | | |
| 15 | d-limonene | ND-11 (3) | air (2000) | 2 weeks | 135 | N/D |
| | (200) | | | | | |
| 16 | α-terpinene | ND-11 (3) | air (2000) | 2 weeks | 135 | N/D |
| | (200) | | | | | |
| 17 | d-limonene | ND-12 (3) | air (2000) | 2 weeks | 135 | N/D |
| | (200) | | | | | |
| 18 | α-terpinene | ND-12 (3) | air (2000) | 2 weeks | 135 | N/D |
| | (200) | | | | | |
| Control 7 | None | None | air (10000) | 2 weeks | 135 | >3 |
| 19 | d-limonene | POE32-3MAF (3) | air (10000) | 2 weeks | 135 | N/D |
| | (1000) | | | | | |
| 20 | α-terpinene | POE32-3MAF (3) | air (10000) | 2 weeks | 135 | N/D |
| | (1000) | | | | | |
| 21 | d-limonene | ND-11 (3) | air (10000) | 2 weeks | 135 | N/D |
| | (1000) | | | | | |
| 22 | α-terpinene | ND-11 (3) | air (10000) | 2 weeks | 135 | N/D |
| | (1000) | | | | | |
| 23 | d-limonene | ND-12 (3) | air (10000) | 2 weeks | 135 | N/D |
| | (1000) | | | | | |
| 24 | α-terpinene | ND-12 (3) | air (10000) | 2 weeks | 135 | N/D |
| | (1000) | | | | | |

For Control 7, refrigerant blend comprising the above mixture of (E)-HFO-1132, CFC-32, and HFO-1234yf (30 g) and 10000 ppm of the initiator (air) is added to a 210-mL shaker tube. The shaker tube is maintained at the temperature and for the period of time given in Table 3.

For Examples 19-24, the inhibitor and the lubricant listed in Table 3 are added to the same refrigerant blend and initiator as in Control 7 in a 210-mL shaker tube. The shaker tube is maintained at the temperature and for the period of time given in Table 3.

Greater than 3 wt % of the refrigerant is expected to polymerize without an inhibitor under the test conditions for Control 7. Inclusion of the inhibitor in the amounts listed for Examples 19-24 for the conditions listed in Table 3 is expected to stabilize the refrigerant blend and produce no detectable amount of polymerization of the refrigerant.

### Example 4

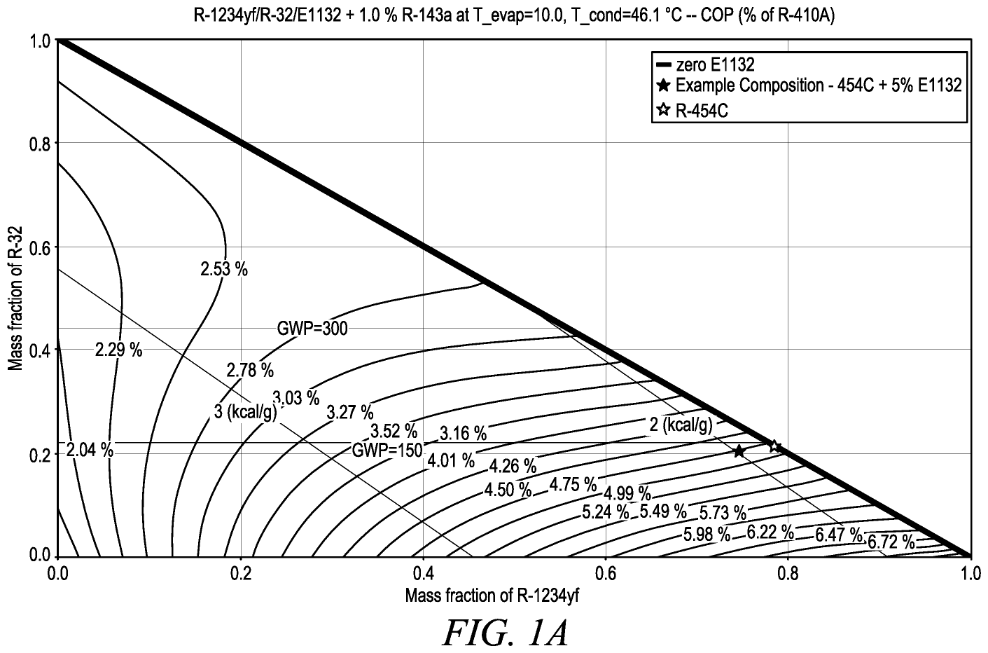

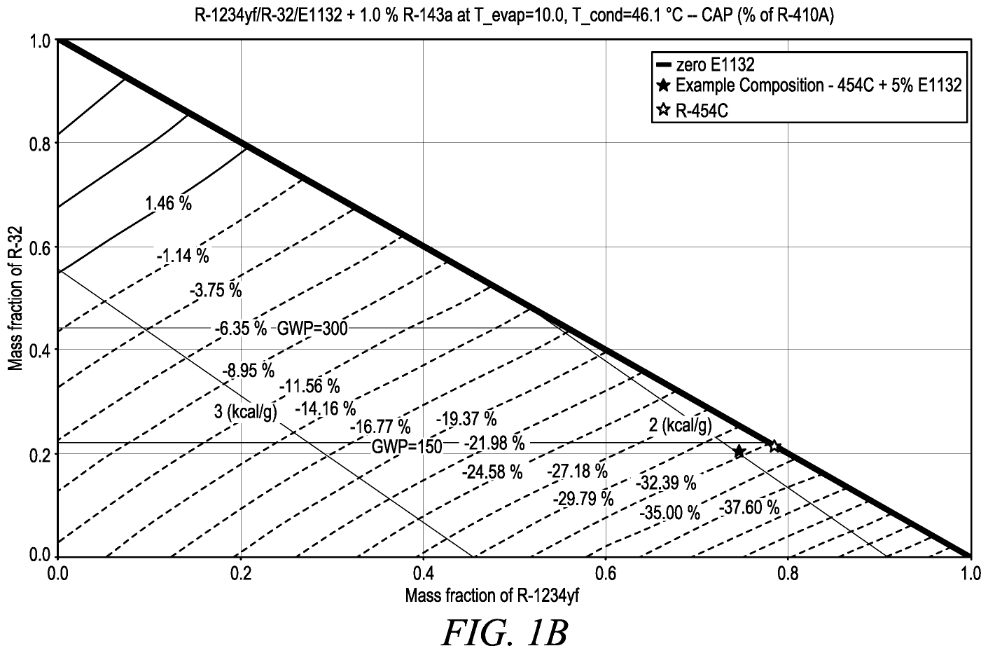

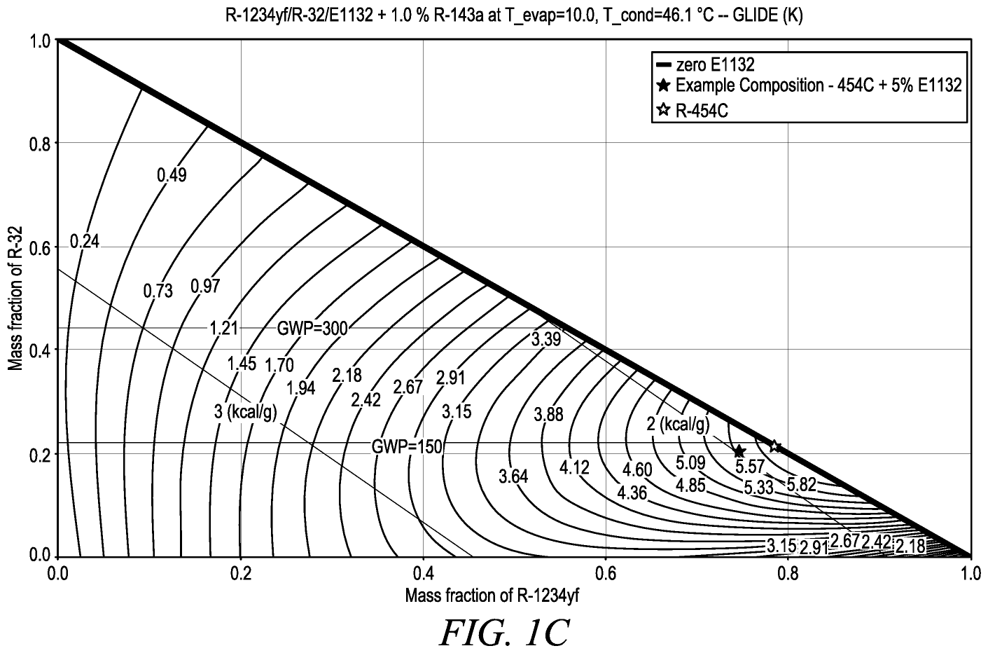

The inventive stabilized fluoroethylene compositions can be used for refrigerant applications. FIGS. 1A, 1B and 1C are charts which illustrate the refrigeration performance of compositions comprising 1234yf, 1132(E), 32 and 143a.

### Example 5

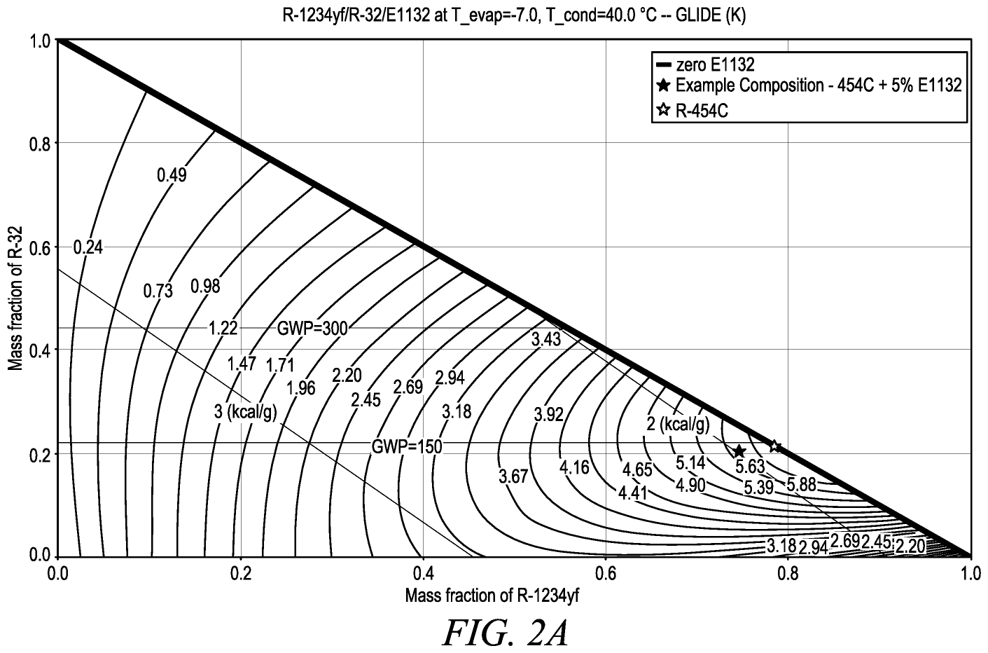

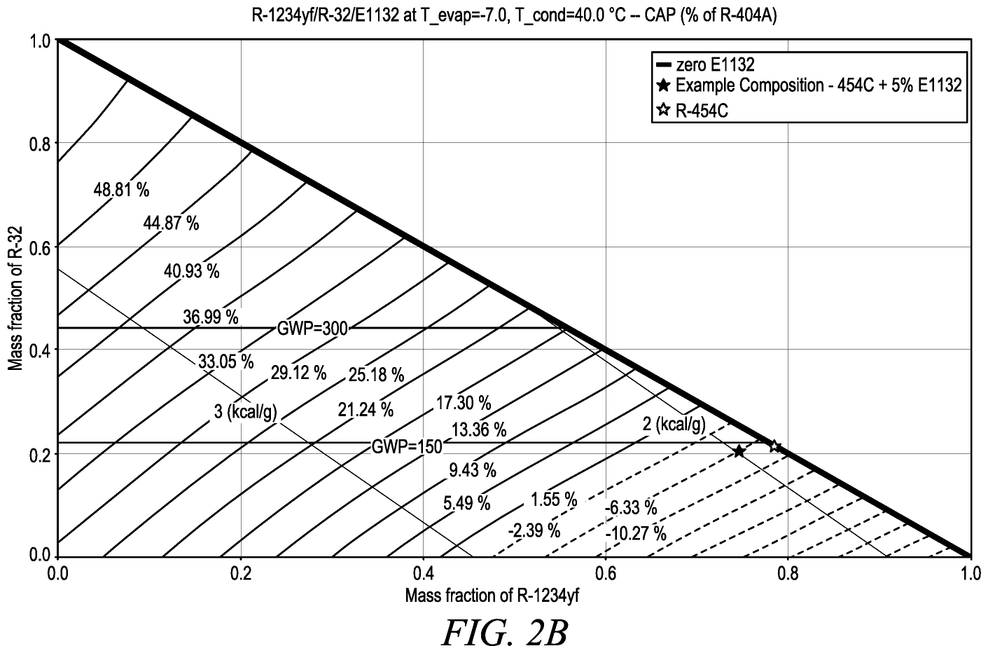

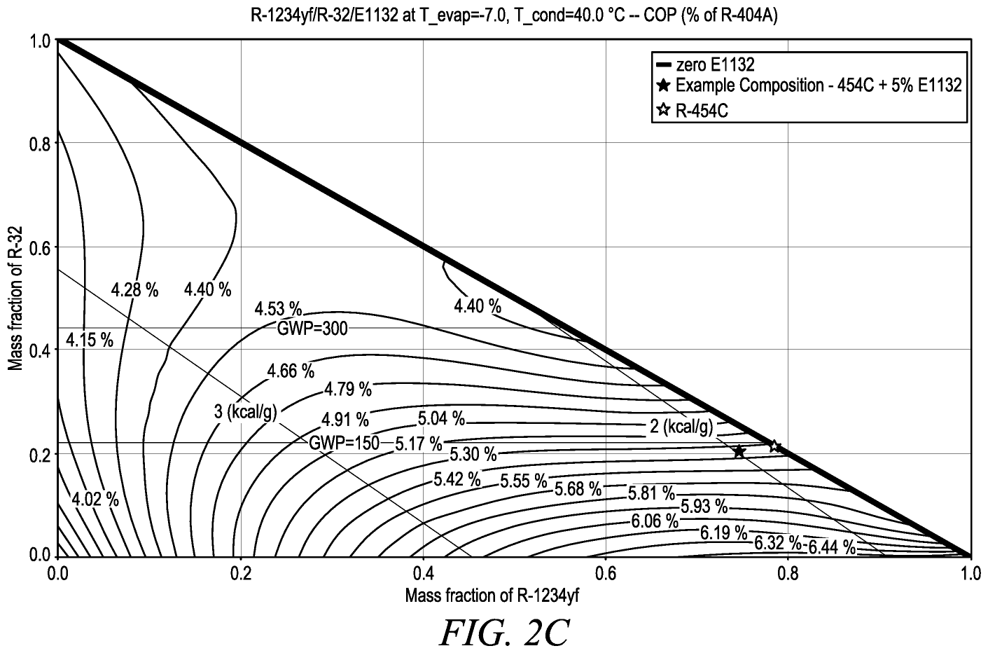

The inventive stabilized fluoroethylene compositions can be used for refrigerant applications. FIGS. 2A, 2B and 2C are charts which illustrate the refrigeration performance of compositions comprising 1234yf, 1132(E), and 32 and show that the inventive compositions can be employed under conditions similar to conventionally used R-404A.

### Example 6

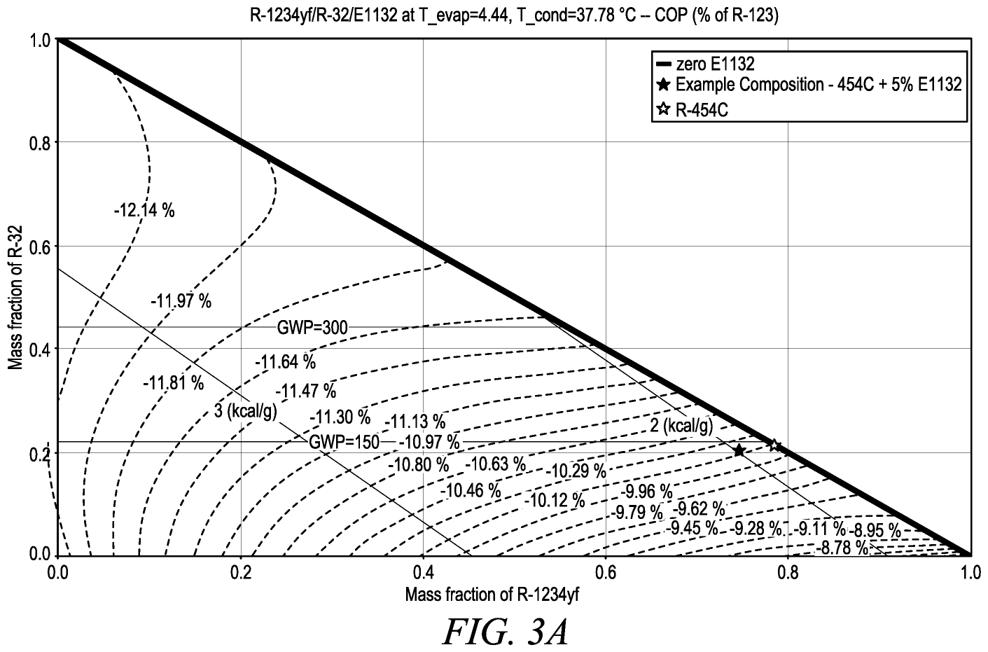

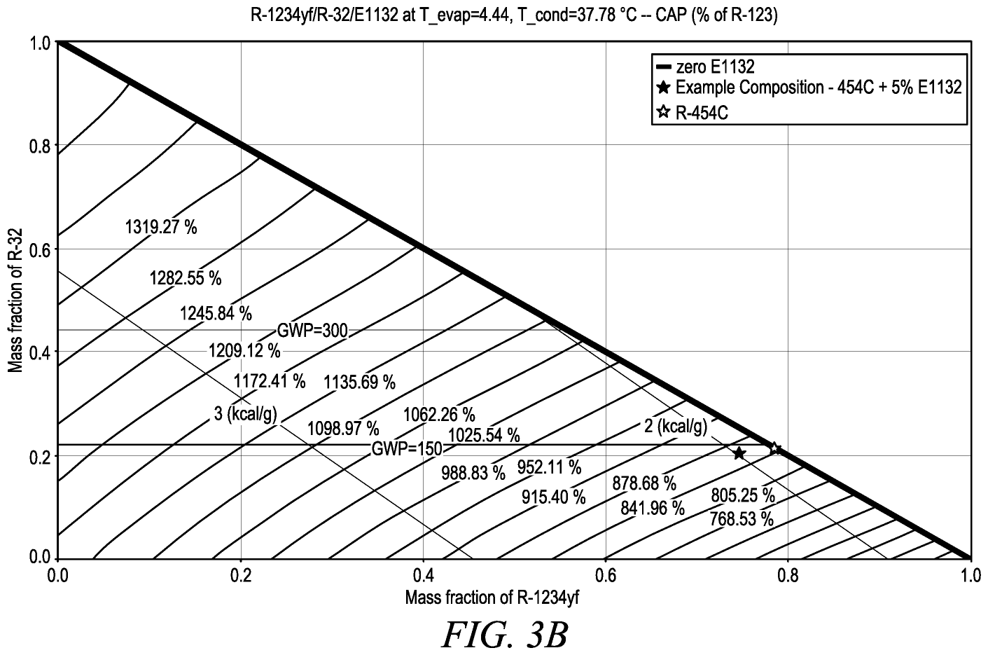

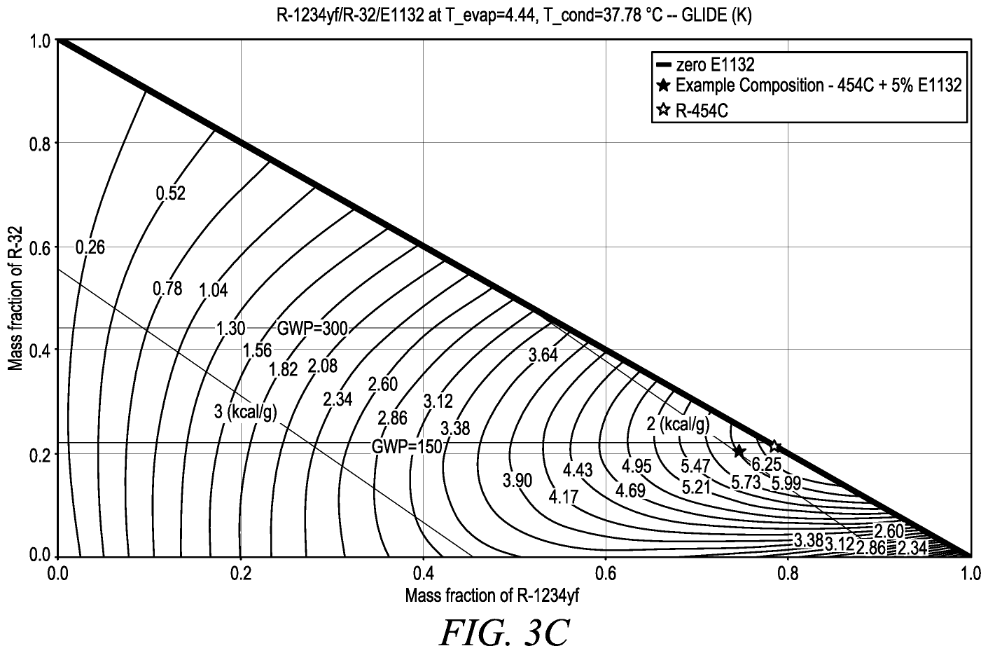

The inventive stabilized fluoroethylene compositions can be used for refrigerant applications. FIGS. 3A, 3B and 3C are charts which illustrate the refrigeration performance of compositions comprising 1234yf, 1132(E), and 32 and show that the inventive compositions can be employed under conditions similar to conventionally used R-123.

### Example 7

The mixture of (E)1132a (30 g) and an initiator with or without inhibitor is heated in a 210 mL shake tube for a period of time. The shake tube is cooled to room temperature and visually examined for polymer formation. The results are shown below in Table 4.

TABLE 4

| | | concen. | | | T | polymer |
|---|---|---|---|---|---|---|
| Examples | Inhibitor | (ppm) | Initiator | time | (° C.) | (wt %) |
| Control-1 | None | | air | two | 100 | >1 |
| | | | (3300 ppm) | weeks | | |
| 1 | meta-xylene | 500 | air | two | 100 | <0.1 |
| | | ppm | (3300 ppm) | weeks | | |
| 2 | alpha- | 1500 | air | two | 100 | <0.1 |
| | methylstyrene | ppm | (3300 ppm) | weeks | | |
| 3 | alpha meta- | 3000 | air | two | 100 | <0.1 |
| | methylstyrene | ppm | (3300 ppm) | weeks | | |
| Control-2 | None | | air | two | 100 | >3 |
| | | | (10,000 ppm) | weeks | | |
| 4 | meta-xylene | 500 | air | two | 100 | <1 |
| | | ppm | (10,000 ppm) | weeks | | |
| 5 | alpha- | 1000 | air | two | 100 | <1 |
| | methylstyrene | ppm | (10,000 ppm) | weeks | | |
| 6 | alpha meta- | 1000 | air | two | 100 | <1 |
| | methylstyrene | ppm | (10,000 ppm) | weeks | | |

### Example 8

The following blends E-1132/1234yf (23/77 by wt); E-1132/32 (56/44 by wt); and E-1132/32/1234yf (32/44.2/23.8 by wt) are evaluated in accordance with the method of Example 7. The results of the evaluation are listed in Table 5.

TABLE 5

| | refrigrent | | concen. | | Concentration | | | T | Polymer |
|---|---|---|---|---|---|---|---|---|---|
| Examples | blends | Inhibitor | (ppm) | Lubricant | (wt %) | Initiator | time | (° C.) | (wt %) |
| Control-3 | E- | None | | | | air | two | 135 | >0.1 |
| | 1132/32/1234yf | | | | | (2000 | weeks | | |
| | | | | | | ppm) | | | |
| 1 | E- | meta-xylene | 500 | POE32- | 3 | air | two | 135 | N/D |
| | 1132/32/1234yf | | | 3MAF | | (2000 | weeks | | |
| | | | | | | ppm) | | | |
| 2 | E- | alpha- | 500 | POE32- | 3 | air | two | 135 | N/D |
| | 1132/32/1234yf | methylstyrene | | 3MAF | | (2000 | weeks | | |
| | | | | | | ppm) | | | |
| 3 | E- | meta-xylene | 500 | ND-11 | 3 | air | two | 135 | N/D |
| | 1132/32/1234yf | | | | | (2000 | weeks | | |
| | | | | | | ppm) | | | |
| 4 | E- | alpha- | 500 | ND-11 | 3 | air | two | 135 | N/D |
| | 1132/32/1234yf | methylstyrene | | | | (2000 | weeks | | |
| | | | | | | ppm) | | | |
| 5 | E- | meta-xylene | 500 | ND-12 | 3 | air | two | 135 | N/D |
| | 1132/32/1234yf | | | | | (2000 | weeks | | |
| | | | | | | ppm) | | | |
| 6 | E- | alpha- | 500 | ND-12 | 3 | air | two | 135 | N/D |
| | 1132/32/1234yf | methylstyrene | | | | (2000 | weeks | | |
| | | | | | | ppm) | | | |
| Control-4 | E- | None | | | | air | two | 135 | >3% |
| | 1132/32/1234yf | | | | | (10,000 | weeks | | |
| | | | | | | ppm) | | | |
| 7 | E- | meta-xylene | 500 | POE32- | 3 | air | two | 135 | N/D |
| | 1132/32/1234yf | | | 3MAF | | (10,000 | weeks | | |
| | | | | | | ppm) | | | |
| 8 | E- | alpha- | 500 | POE32- | 3 | air | two | 135 | N/D |
| | 1132/32/1234yf | methylstyrene | | 3MAF | | (10,000 | weeks | | |
| | | | | | | ppm) | | | |
| 9 | E- | meta-xylene | 500 | ND-11 | 3 | air | two | 135 | N/D |
| | 1132/32/1234yf | | | | | (10,000 | weeks | | |
| | | | | | | ppm) | | | |
| 10 | E- | alpha- | 500 | ND-11 | 3 | air | two | 135 | N/D |
| | 1132/32/1234yf | methylstyrene | | | | (10,000 | weeks | | |
| | | | | | | ppm ) | | | |
| 11 | E- | meta-xylene | 500 | ND-12 | 3 | air | two | 135 | N/D |
| | 1132/32/1234yf | | | | | (10,000 | weeks | | |
| | | | | | | ppm) | | | |
| 12 | E- | alpha- | 500 | ND-12 | 3 | air | two | 135 | N/D |
| | 1132/32/1234yf | methylstyrene | | | | (10,000 | weeks | | |
| | | | | | | ppm) | | | |
| Control-5 | E-1132/1234yf | None | | | | air | two | 135 | >0.1% |
| | | | | | | (2000 | weeks | | |
| | | | | | | ppm) | | | |
| 1 | E-1132/1234yf | meta-xylene | 500 | POE32- | 3 | air | two | 135 | N/D |
| | | | | 3MAF | | (2000 | weeks | | |
| | | | | | | ppm) | | | |
| 2 | E-1132/1234yf | alpha- | 500 | POE32- | 3 | air | two | 135 | N/D |
| | | methylstyrene | | 3MAF | | (2000 | weeks | | |
| | | | | | | ppm) | | | |
| 3 | E-1132/1234yf | meta-xylene | 500 | ND-11 | 3 | air | two | 135 | N/D |
| | | | | | | (2000 | weeks | | |
| | | | | | | ppm) | | | |
| 4 | E-1132/1234yf | alpha- | 500 | ND-11 | 3 | air | two | 135 | N/D |
| | | methylstyrene | | | | (2000 | weeks | | |
| | | | | | | ppm) | | | |
| 5 | E-1132/1234yf | meta-xylene | 500 | ND-12 | 3 | air | two | 135 | N/D |
| | | | | | | (2000 | weeks | | |
| | | | | | | ppm) | | | |
| 6 | E-1132/1234yf | alpha- | 500 | ND-12 | 3 | air | two | 135 | N/D |
| | | methylstyrene | | | | (2000 | weeks | | |
| | | | | | | ppm) | | | |
| Control-6 | E-1132/32 | None | | | | air | two | 135 | >1% |
| | | | | | | (10,000 | weeks | | |
| | | | | | | ppm) | | | |
| 7 | E-1132/32 | meta-xylene | 500 | POE32- | 3 | air | two | 135 | N/D |
| | | | | 3MAF | | (10,000 | weeks | | |
| | | | | | | ppm) | | | |
| 8 | E-1132/32 | alpha- | 500 | POE32- | 3 | air | two | 135 | N/D |
| | | methylstyrene | | 3MAF | | (10,000 | weeks | | |
| | | | | | | ppm) | | | |
| 9 | E-1132/32 | meta-xylene | 500 | ND-11 | 3 | air | two | 135 | N/D |
| | | | | | | (10,000 | weeks | | |
| | | | | | | ppm) | | | |
| 10 | E-1132/32 | alpha- | 500 | ND-11 | 3 | air | two | 135 | N/D |
| | | methylstyrene | | | | (10,000 | weeks | | |
| | | | | | | ppm ) | | | |
| 11 | E-1132/32 | meta-xylene | 500 | ND-12 | 3 | air | two | 135 | N/D |
| | | | | | | (10,000 | weeks | | |
| | | | | | | ppm) | | | |
| 12 | E-1132/32 | alpha- | 500 | ND-12 | 3 | air | two | 135 | N/D |
| | | methylstyrene | | | | (10,000 | weeks | | |
| | | | | | | ppm) | | | |

### Example 9

The refrigeration performance of the compositions disclosed in Example 8 were evaluated using computer modeling. The results are presented in Table 6.

TABLE 6
Cycle Calcs - ThermPy based on Refprop 10

| AC Cooling Conditions | | |
|---|---|---|
| Evaporator temperature | 4° | C. |
| Condenser temperature | 40° | C. |
| Subcool amount | 0 | K |
| Superheat Temperature | 15 | K |

| | |
|---|---|
| Compressor efficiency | 70% |

| | | | | | | Cooling | | Cooling |
|---|---|---|---|---|---|---|---|---|
| | | | Compr | Average | | CAP | | COP |
| | Evap | Cond | Disch | Temp | Cooling | relative | | relative |
| | Press | Press | Temp | Glide | CAP | to base | Cooling | to base |
| | (kPa) | (kPa) | (C.) | (K) | (kJ/m³) | (%) | COP | (%) |
| 1132E/1234yf at | | | | | | | | |
| 23/77 wt % plus | | | | | | | | |
| m-xylene | | | | | | | | |
| 23/77 base | 517 | 1440 | 68.2 | 4.6 | 3267 | 100.0 | 4.284 | 100.0 |
| 23/76.98/0.02 | 505 | 1432 | 69.6 | 5.6 | 3203 | 98.0 | 4.220 | 98.5 |
| 23/76.96/0.04 | 493 | 1424 | 71.2 | 6.6 | 3134 | 95.9 | 4.151 | 96.9 |
| 23/76.94/0.06 | 480 | 1415 | 72.9 | 7.6 | 3059 | 93.6 | 4.075 | 95.1 |
| 23/76.9/0.1 | 450 | 1397 | 77.0 | 10.0 | 2887 | 88.4 | 3.900 | 91.0 |
| 1132a/32/1234yf at | | | | | | | | |
| 5/44/51 wt % plus | | | | | | | | |
| m-xylene | | | | | | | | |
| 5/44/51 base | 797 | 2166 | 81.4 | 5.1 | 4846 | 100.0 | 4.116 | 100.0 |
| 5/44/50.98/0.02 | 784 | 2158 | 82.7 | 5.8 | 4772 | 98.5 | 4.065 | 98.8 |
| 5/44/50.96/0.04 | 770 | 2150 | 84.1 | 6.5 | 4694 | 96.9 | 4.009 | 97.4 |
| 5/44/50.94/0.06 | 756 | 2142 | 85.6 | 7.2 | 4610 | 95.1 | 3.950 | 96.0 |
| 5/44/50.9/0.1 | 723 | 2125 | 89.2 | 9.0 | 4418 | 91.2 | 3.812 | 92.6 |
| 1132E/32/1234yf at | | | | | | | | |
| 32/44/24 wt % plus | | | | | | | | |
| m-xylene | | | | | | | | |
| 32/44/24 base | 861 | 2295 | 86.1 | 1.3 | 5258 | 100.0 | 4.157 | 100.0 |
| 32/44/23.98/0.02 | 844 | 2285 | 87.8 | 2.1 | 5159 | 98.1 | 4.090 | 98.4 |
| 32/44/23.96/0.04 | 827 | 2275 | 89.6 | 2.9 | 5056 | 96.2 | 4.020 | 96.7 |
| 32/44/23.94/0.06 | 809 | 2265 | 91.6 | 3.8 | 4948 | 94.1 | 3.946 | 94.9 |
| 32/44/23.9/0.1 | 769 | 2245 | 96.1 | 5.7 | 4707 | 89.5 | 3.783 | 91.0 |
| 1123/32/1234yf at | | | | | | | | |
| 19/55/26 wt % plus | | | | | | | | |
| m-xylene | | | | | | | | |
| 19/55/26 base | 921 | 2445 | 84.9 | 2.2 | 5495 | 100.0 | 4.090 | 100.0 |
| 19/55/25.98/0.02 | 908 | 2437 | 86.2 | 2.9 | 5417 | 98.6 | 4.040 | 98.8 |
| 19/55/25.96/0.04 | 893 | 2428 | 87.6 | 3.5 | 5334 | 97.1 | 3.988 | 97.5 |
| 19/55/25.94/0.06 | 878 | 2420 | 89.1 | 4.2 | 5248 | 95.5 | 3.933 | 96.2 |
| 19/55/25.9/0.1 | 846 | 2402 | 92.5 | 5.7 | 5056 | 92.0 | 3.810 | 93.2% |

### Example 10

The refrigeration performance of compositions comprising 1132E, 1234yf and propane were evaluated using computer modeling. The results of the evaluation are given below in Table 7.

TABLE 7
Cycle Calcs - ThermPy based on Refprop 10

| AC Cooling Conditions | | |
|---|---|---|
| Evaporator temperature | 4° | C. |
| Condenser temperature | 40° | C. |
| Subcool amount | 0 | K |
| Superheat Temperature | 15 | K |

| | |
|---|---|
| Compressor efficiency | 70% |

| | | | | | | Cooling | | Cooling |
|---|---|---|---|---|---|---|---|---|
| | | | Compr | Average | | CAP | | COP |
| | Evap | Cond | Disch | Temp | Cooling | relative | | relative |
| | Press | Press | Temp | Glide | CAP | to base | Cooling | to base |
| | (kPa) | (kPa) | (C.) | (K) | (kJ/m³) | (%) | COP | (%) |
| 1132E/1234yf at | | | | | | | | |
| 23/77 wt % plus | | | | | | | | |
| propane | | | | | | | | |
| 23/77 base | 517 | 1440 | 68.2 | 4.6 | 3267 | 100.0 | 4.284 | 100.0 |
| 23/76.9/0.1 | 518 | 1442 | 682 | 4.6 | 3270 | 100.1 | 4.284 | 100.0 |
| 23/76.7/0.3 | 519 | 1444 | 68.2 | 4.6 | 3275 | 100.2 | 4.283 | 100.0 |
| 23/76.5/0.5 | 520 | 1446 | 68.2 | 4.6 | 3279 | 100.4 | 4.282 | 100.0 |
| 23/76/1 | 523 | 1452 | 68.2 | 4.5 | 3291 | 100.7 | 4.280 | 99.9 |
| 23/74/3 | 535 | 1474 | 68.1 | 4.1 | 3335 | 102.1 | 4.271 | 99.7 |
| 23/72/5 | 546 | 1495 | 68.1 | 3.7 | 3376 | 103.3 | 4.264 | 99.5 |
| 1132a/32/1234yf at | | | | | | | | |
| 5/44/51 wt % plus | | | | | | | | |
| propane | | | | | | | | |
| 5/44/51 base | 797 | 2166 | 81.4 | 5.1 | 4846 | 100.0 | 4.116 | 100.0 |
| 5/44/50.9/0.1 | 798 | 2170 | 81.4 | 5.2 | 4851 | 100.1 | 4.115 | 100.0 |
| 5/44/50.7/0.3 | 801 | 2176 | 81.4 | 5.2 | 4863 | 100.4 | 4.112 | 99.9 |
| 5/44/50.5/0.5 | 804 | 2183 | 81.4 | 5.2 | 4873 | 100.6 | 4.109 | 99.8 |
| 5/44/50/1 | 811 | 2199 | 81.4 | 5.2 | 4900 | 101.1 | 4.102 | 99.7 |
| 5/44/48/3 | 839 | 2261 | 81.4 | 5.4 | 5001 | 103.2 | 4.075 | 99.0 |
| 5/44/46/5 | 866 | 2318 | 81.2 | 5.4 | 5090 | 105.0 | 4.050 | 98.4 |
| 1132E/32/1234yf at | | | | | | | | |
| 32/44/24 wt % plus | | | | | | | | |
| propane | | | | | | | | |
| 32/44/24 base | 861 | 2295 | 86.1 | 1.3 | 5258 | 100.0 | 4.157 | 100.0 |
| 32/44/23.9/0.1 | 862 | 2297 | 86.1 | 1.3 | 5262 | 100.1 | 4.156 | 100.0 |
| 32/44/23.7/0.3 | 864 | 2301 | 86.1 | 1.3 | 5268 | 100.2 | 4.154 | 99.9 |
| 32/44/23.5/0.5 | 866 | 2305 | 86.1 | 1.3 | 5275 | 100.3 | 4.152 | 99.9 |
| 32/44/23/1 | 871 | 2315 | 86.0 | 1.3 | 5291 | 100.6 | 4.148 | 99.8 |
| 32/44/21/3 | 890 | 2354 | 85.7 | 1.4 | 5353 | 101.8 | 4.130 | 99.4 |
| 32/44/19/5 | 907 | 2389 | 85.4 | 1.4 | 5407 | 102.8 | 4.115 | 99.0 |
| 1123/32/1234yf at | | | | | | | | |
| 19/55/26 wt % plus | | | | | | | | |
| propane | | | | | | | | |
| 19/55/26 base | 921 | 2445 | 84.9 | 2.2 | 5495 | 100.0 | 4.090 | 100.0 |
| 19/55/25.9/0.1 | 923 | 2449 | 84.9 | 2.3 | 5501 | 100.1 | 4.089 | 100.0 |
| 19/55/25.7/0.3 | 926 | 2456 | 84.9 | 2.3 | 5513 | 100.3 | 4.085 | 99.9 |
| 19/55/25.5/0.5 | 930 | 2464 | 84.9 | 2.3 | 5524 | 100.5 | 4.081 | 99.8 |
| 19/55/25/1 | 938 | 2482 | 84.9 | 2.4 | 5553 | 101.1 | 4.073 | 99.6 |
| 19/55/23/3 | 970 | 2553 | 84.7 | 2.6 | 5658 | 103.0 | 4.040 | 98.8 |
| 19/55/21/5 | 1000 | 2617 | 84.4 | 2.6 | 5751 | 104.7 | 4.009 | 98.0 |

Although certain aspects, embodiments and principals have been described above, it is understood that this description is made only way of example and not as limitation of the scope of the invention or appended claims. The foregoing various aspects, embodiments and principals can be used alone and in combinations with each other.

1. A stabilized composition comprising at least one fluoroethylene and an effective amount of at least one inhibitor, wherein the composition is substantially free of oligomeric, homopolymers or other polymeric products derived from the fluoroethylene.

2. The composition of claim 1 wherein the at least one fluoroethylene comprises at least one difluoroethylene.

3. The composition of claim 2 wherein the at least one difluoroethylene comprises 1,1-difluoroethylene (HFO-1132a) or (E)-1,2-difluoroethylene ((E)-HFO-1132).

4. (canceled)

5. The composition of claim 1 wherein the at least one inhibitor is selected from (i) the group consisting of terpenes, terpenoids, and linear unsaturated hydrocarbons; or (ii) the group consisting of D-limonene, terpinene, pinene, p-cymene, terpineol, myrcene, farnesene, 4-methoxyphenol, butylated hydroxytoluene, butylated hydroxyanisole, tert-butylhydroquinone, Meta-xylene, ortho-xylene, para-xylene, alpha-methylstyrene, alpha meta-methylstyrene, alpha ortho-methylstyrene, and alpha para-methylstyrene.

6. (canceled)

7. The composition of claim 1 wherein the at least one inhibitor is present in an amount in the range of about 30 ppm to about 3,000 ppm.

8. The composition of claim 1 further comprising at least one lubricant.

9. The composition of claim 1 wherein the composition comprises less than about 0.03 wt % of oligomeric, homopolymers or other polymeric products.

10. The composition of claim 1 further comprising at least one initiator selected from the group consisting of air, oxygen, cumene hydroperoxide, fluoroolefin polyperoxides, peroxides, hydroperoxides, persulfates, percarbonates, perborates, and hydropersulfates.

11.-12. (canceled)

13. A composition comprising at least one fluoroethylene; vinyl fluoride (HFO-1141); and at least one additional compound selected from the group consisting of chlorotrifluoromethane (CFC-13), trifluoromethane (CFC-23), difluoromethane (CFC-32), 1-chloro-1,1-difluoroethane (HFC-142b), 1,1,1-trifluoroethane (HFC-143a), tetrafluoroethylene (HFO-1114), 1-chloro-2,2-difluoroethylene (HFO-1122), acetylene, ethylene, 1,2-dichloro-1,2-difluoroethane (HFC-132), 1,1,2-trifluoroethane (HFC-143), 1-chloro-1,2-difluoroethylene (HFO-1122a), trifluoroethylene (HFO-1123), 1-chloro-2-fluoroethylene (HFO-1131), (Z)-1,2-difluoroethylene ((Z)-HFO-1132), and combinations thereof, in an amount of at least 0.001% by weight.

14. The composition of claim 13 wherein the at least one fluoroethylene comprises at least one difluoroethylene.

15. The composition of claim 14 wherein the at least one difluoroethylene comprises 1,1-difluoroethylene (HFO-1132a) or (E)-1,2-difluoroethylene ((E)-HFO-1132).

16. The composition of claim 15,
wherein the at least one difluoroethylene comprises 1,1-difluoroethylene (HFO-1132a) and the at least one additional compound is selected from the group consisting of chlorotrifluoromethane (CFC-13), trifluoromethane (CFC-23), difluoromethane (CFC-32), 1-chloro-1,1-difluoroethane (HFC-142b), 1,1,1-trifluoroethane (HFC-143a), tetrafluoroethylene (HFO-1114), 1-chloro-2,2-difluoroethylene (HFO-1122), and combinations thereof; or
wherein the at least one difluoroethylene comprises (E)-1,2-difluoroethylene ((E)-HFO-1132) and the at least one additional compound is selected from the group consisting of acetylene, ethylene, 1,2-dichloro-1,2-difluoroethane (HFC-132), HFC-32, 1,1,2-trifluoroethane (HFC-143), 1,1,1-trifluoroethane (HFC-143a), 1-chloro-1,2-difluoroethylene (HFO-1122a), trifluoroethylene (HFO-1123), 1-chloro-2-fluoroethylene (HFO-1131), (Z)-1,2-difluoroethylene ((Z)-HFO-1132)), propane, and combinations thereof.

17.-18. (canceled)

19. The composition of claim 13 further comprising an effective amount of at least one inhibitor such that the composition is substantially free of oligomeric, homopolymers or other polymeric products derived from the fluoroethylene.

20. The composition of claim 19 wherein the at least one inhibitor is selected from (i) the group consisting of terpenes, terpenoids, linear unsaturated hydrocarbons, and phenolics; or (ii) the group consisting of D-limonene, terpinene, pinene, p-cymene, terpineol, myrcene, farnesene, 4-methoxyphenol, butylated hydroxytoluene, butylated hydroxyanisole, tert-butylhydroquinone, Meta-xylene, ortho-xylene, para-xylene, alpha-methylstyrene, alpha meta-methylstyrene, alpha ortho-methylstyrene, and alpha para-methylstyrene.

21. The composition of claim 19 wherein the at least one inhibitor is present in an amount of about 30 ppm to about 3,000 ppm.

22. (canceled)

23. The composition of claim 19 wherein the composition comprises less than about 0.03 wt % of oligomeric, homopolymers or other polymeric products.

24. The composition of claim 19 further comprising at least one member selected from the group consisting of air, oxygen, cumene hydroperoxide, and fluoroolefin polyperoxides, peroxides, hydroperoxides, persulfates, percarbonates, perborates, and hydropersulfates.

25. The composition of claim 13 further comprising at least one lubricant.

26. A method for heating or cooling comprising:
condensing a refrigerant composition from a vapor phase to a liquid phase in a refrigerant loop, the refrigerant composition comprising the stabilized composition of claim 1, the effective amount of the at least one inhibitor being effective to reduce oligomer or homopolymer formation from the at least one fluoroethylene; and
thereafter evaporating said refrigerant composition from the liquid phase to the vapor phase in the refrigerant loop.

27. (canceled)

28. The method of claim 26 further comprising providing lubricant to the refrigerant loop, wherein the inhibitor is present in the liquid phase and the lubricant, and wherein the vapor phase is substantially free of the inhibitor.

29.-32. (canceled)
